(19) United States
(12) Patent Application Publication
(10) Pub. No.: US 2025/0200230 A1
(43) Pub. Date: Jun. 19, 2025

(54) IMAGE FORMING APPARATUS AND INFORMATION TRANSMISSION METHOD

(71) Applicant: SEIKO EPSON CORPORATION, TOKYO (JP)

(72) Inventor: Kikuo UENO, MATSUMOTO-SHI (JP)

(21) Appl. No.: 18/981,469

(22) Filed: Dec. 14, 2024

(30) Foreign Application Priority Data
Dec. 15, 2023 (JP) 2023-211888

(51) Int. Cl. G06F 21/84; G06F 21/62; H04N 1/00

(52) U.S. Cl. CPC G06F 21/84; G06F 21/6245; H04N 1/00424

(57) ABSTRACT

An image forming apparatus in an aspect of the present disclosure includes a communication unit, an operation unit, a display unit that displays an operation image operable from the operation unit, a transmission processing unit, and a switching unit. The transmission processing unit transmits display information for displaying a remote operation image to an external device via the communication unit. A first mode is a mode in which prescribed information included in part of the operation image is includes in the display information and registration information that is information registered by a user, the registration information being included in part of the operation image, is included in the display information. A second mode is a mode in which the prescribed information is included in the display information and the registration information is not included in the display information.

The present application is based on, and claims priority from JP Application Serial Number 2023-211888, filed Dec. 15, 2023, the disclosure of which is hereby incorporated by reference herein in its entirety.

### BACKGROUND

### 1. Technical Field

The present disclosure relates to an image forming apparatus and an information transmission method.

### 2. Related Art

It has long been known to display the operation panel of a printing device on a browser or the like of a terminal device at a remote location. For example, JP-A-2006-212893 discloses a technique that enables a change in language when displaying an operation panel in the browser of a terminal device.

In recent years, there has been a growing awareness of the need to protect personal information. The inventors considered temporarily blocking the display of the operation panel at the remote location in order to prevent personal information and other information from being viewed at the remote location. However, with such blocking, problems arise such as the inability of a substitute operator to operate the system from a remote location. The technique described in JP-A-2006-212893 is not capable of solving such problems.

Therefore, it is desirable to develop a technique that enables protection of information while allowing operation from an external device when displaying part or all of the operation image of an image forming apparatus from an external device via a network and performing an operation.

### SUMMARY

According to an aspect of the present disclosure, an image forming apparatus includes a communication unit, an operation unit, a display unit displaying an operation image operable from the operation unit, a transmission processing unit transmitting, via the communication unit, display information for displaying a remote operation image based on the operation image to an external device, and a switching unit for switching a disclosure mode for information disclosure in the remote operation image, wherein the disclosure mode includes a first mode in which prescribed information included in part of the operation image is included in the display information and registration information that is information registered by a user is included in the display information, the registration information being included in part of the operation image, and a second mode in which the prescribed information is included in the display information and the registration information is not included in the display information.

According to another aspect of the present disclosure, an information transmission method includes an image forming apparatus transmitting, via a communication unit, display information for displaying a remote operation image based on the operation image to an external device, the image forming apparatus including the communication unit, an operation unit, and a display unit displaying an operation image operable from the operation unit, and the image forming apparatus switching a disclosure mode regarding information disclosure in the remote operation image, wherein the disclosure mode includes a first mode in which prescribed information included in part of the operation image is included in the display information and registration information that is information registered by a user is included in the display information, the registration information being included in part of the operation image, and a second mode in which the prescribed information is included in the display information and the registration information is not included in the display information.

### BRIEF DESCRIPTION OF THE DRAWINGS

FIG. 1 is a block diagram showing a configuration example of an image forming system including an image forming apparatus and an external device according to an embodiment.

FIG. 2 is a flow diagram for describing a processing example of the image forming apparatus in the image forming system shown in FIG. 1.

FIG. 3 is a flow diagram for describing an example of a display component protection process in the processing example of FIG. 2.

FIG. 4 shows an example of a table to be referenced to in the process of FIG. 2.

FIG. 5 is a schematic diagram showing an example of an operation image in a standard mode displayed in the image forming system shown in FIG. 1 and an example of a remote operation image displayed corresponding to the operation image.

FIG. 6 is a schematic diagram showing an example of an operation image displayed in the image forming system shown in FIG. 1 in an all-lock mode and an example of a remote operation image displayed corresponding to the operation image.

FIG. 7 is a schematic diagram showing an example of an operation image in a personal information lock mode displayed in the image forming system shown in FIG. 1 and an example of a remote operation image displayed corresponding to the operation image.

FIG. 8 is a schematic diagram showing an example of an operation image displayed when one of the contacts is selected in the operation image of FIG. 7 and an example of a remote operation image displayed corresponding to the operation image.

FIG. 9 is a schematic diagram showing an example of an operation image in a privacy lock mode displayed in the image forming system shown in FIG. 1 and an example of a remote operation image displayed corresponding to the operation image.

FIG. 10 is a schematic diagram showing an example of an operation image in a personal information and privacy lock mode displayed in the image forming system shown in FIG. 1 and an example of a remote operation image displayed corresponding to the operation image.

FIG. 11 is a schematic diagram showing another example of an operation image in a personal information and privacy lock mode displayed in the image forming system shown in FIG. 1 and an example of a remote operation image displayed corresponding to the operation image.

FIG. 12 is a schematic diagram showing an example of an operation image in a personal information lock mode displayed in the image forming system shown in FIG. 1, an example of an operation image for changing the setting from the operation image to an all-lock mode, and an example of an operation image in the all-lock mode after that change.

FIG. 13 is a flow diagram for describing a processing example of an image forming apparatus in a modification of the image forming system shown in FIG. 1.

FIG. 14 is a flow diagram for describing an example of the display component protection process in the processing example shown in FIG. 13.

FIG. 15 is a schematic diagram showing an example of an operation image in a personal information and privacy lock mode displayed in the processing example shown in FIG. 13 and an example of a remote operation image displayed corresponding to the operation image.

FIG. 16 is a schematic diagram showing another example of an operation image in a personal information and privacy lock mode displayed in the processing example shown in FIG. 13 and an example of a remote operation image displayed corresponding to the operation image.

FIG. 17 is a schematic diagram showing an example of an operation image displayed when setting a simple mode in the image forming apparatus in order to execute the processing example in FIG. 13.

FIG. 18 is a schematic diagram showing another example of an operation image in a personal information and privacy lock mode displayed in the image forming system of FIG. 1.

FIG. 19 is a schematic diagram showing another example of an operation image in an all-lock mode displayed in the image forming system of FIG. 1.

FIG. 20 is a schematic block diagram showing another configuration example of an image forming system including an image forming apparatus and a terminal device according to an embodiment.

FIG. 21 is an example of the hardware configuration of the device.

### DESCRIPTION OF EMBODIMENTS

Hereinafter, embodiments of the present disclosure are described with reference to the drawings. Each drawing is merely an example for describing the present embodiment of the present disclosure. Moreover, not all of the constituent elements described in the present embodiments of the present disclosure are essential constituent elements of the present disclosure.

### EMBODIMENTS

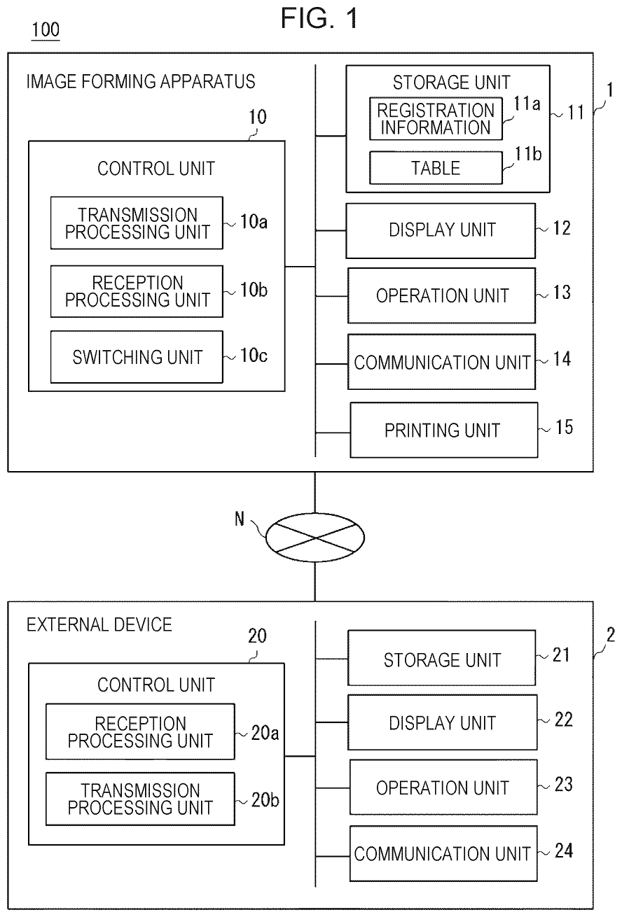

An image forming system including an image forming apparatus and an external device according to an embodiment is described with reference to FIG. 1 FIG. 1 is a block diagram showing a configuration example of such an image forming system.

As shown in FIG. 1, an image forming system (hereinafter referred to as the system) 100 according to the present embodiment can include an image forming apparatus 1 and an external device 2. The external device 2 can be connected to the image forming apparatus 1 via a network N.

### Schematic Configuration of Image Forming Apparatus 1

As shown in FIG. 1, the image forming apparatus 1 can include a control unit 10, a storage unit 11, a display unit 12, an operation unit 13, a communication unit 14, and a printing unit 15.

The control unit 10 of the image forming apparatus 1, which can be referred to as a controller, controls the entire image forming apparatus 1. The control unit 10 can include a transmission processing unit 10a, a reception processing unit 10b, and a switching unit 10c, the details of which are described below.

The control unit 10 can includes, for example, an arithmetic processing unit such as a central processing unit (CPU), a graphics processing unit (GPU), and the like, a working memory, and a storage device that stores control programs and parameters. The control unit 10 can be configured as a system on a chip (SoC). As can be seen from these examples, the control unit 10 can be configured to store the control programs in an executable state. However, the control unit 10 can be configured to store the control programs as a circuit configuration, such as a field-programmable gate array (FPGA), or as a dedicated circuit. The transmission processing unit 10a and the reception processing unit 10b can be implemented as the programs described above. The above program can include a program to implement the functions of the transmission processing unit 10a, the reception processing unit 10b, and the switching unit 10c in cooperation with the storage unit 11, the display unit 12, the operation unit 13, and the communication unit 14. Alternatively, the above program can include a program to implement the functions of the transmission processing unit 10a, the reception processing unit 10b, and the switching unit 10c in cooperation with the storage unit 11, the display unit 12, the operation unit 13, the communication unit 14, and the printing unit 15.

The storage unit 11 includes, for example, a hard disk drive, solid state drive, or another memory. Part of the memory provided by the control unit 10 may be considered as the storage unit 11. The storage unit 11 can be regarded as part of the control unit 10.

The storage unit 11 can store registration information 11a that is information registered by a user. The user here can be a user as an administrator of the image forming apparatus 1, but is only required to be a user of the image forming apparatus 1. The above registration can be done from the operation unit 13, or from an external device connected via a network. The external device that performs the above registration may be the external device 2 that performs the remote operation. In such cases, registration may be performed in a mode in which the registration information 11a is made public among the disclosure modes described below, or the access right regarding registration of the user to the external device 2 may be set.

The registration information 11a can include contact information indicating a contact, user setting information indicating a user setting for the display of the operation image in the image forming apparatus 1, and the like. The contact information can include a phone number, an e-mail address, and the like. The contact information can be referred to as address book information or phone book information.

The above user setting information can include information to reflect the customization of the operation image, for example, when such customization has been made. Customization of the operation image may include, for example, customizing the icon image from the prescribed icon image. The icon image is an image showing an icon that is included in the operation image to select the function such as the copy function that the image forming apparatus 1 has. Of course, the icon image may be an image showing an icon used to select a function other than the function of the image forming apparatus 1. In addition, customization of the operation image can include various customizations, such as customizing the background image that serves as the background in the operation image from the prescribed background image. Thus, the registration information 11a may be, for example, information that has been registered with part of the prescribed information modified by the user.

Customization of the icon image and the background image can be performed by selecting the images from candidate images stored in the storage unit 11, or by the user selecting the image stored in an external recording medium or the like connected to the image forming apparatus 1. Thus, the user setting information can include information indicating the icon image, the background image, and the like as a result of such customization.

The above user setting information may include information indicating a password registered by the user. The password can be, for example, a password used to manage the access right to the image forming apparatus 1, such as the access right to a file stored in the storage unit 11 of the image forming apparatus 1.

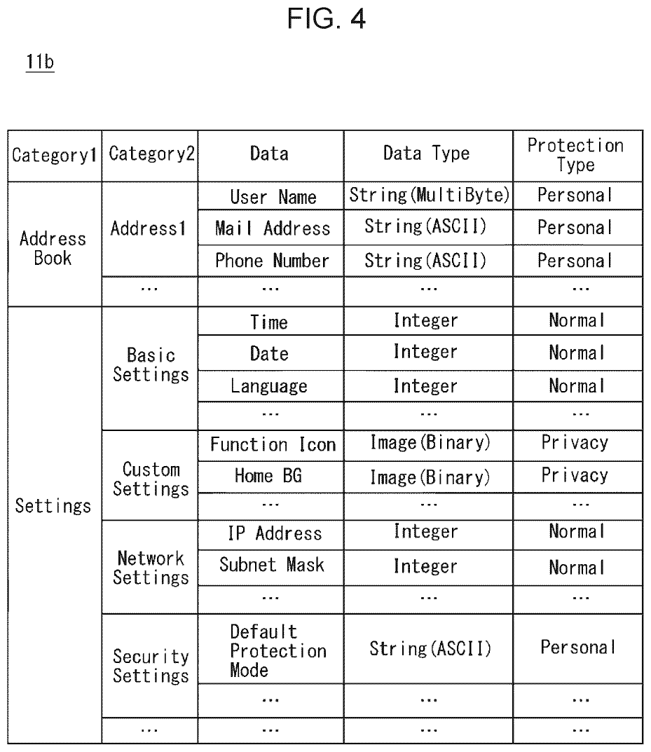

The storage unit 11 can store, for example, a table 11b. The table 11b is described below with reference to FIG. 4. The table 11b refers to a table that stores protection setting information that is setting information about the protection of information.

The display unit 12 is a unit for displaying information. The display unit 12 displays an operation image that is a user interface (UI) image, as at least part of the information. The operation image is an image operable from the operation unit 13. The operation image can be stored in the storage unit 11. The display unit 12 is configured by a display device, such as a liquid crystal display or an organic EL display. The display unit 12 can be configured to include a display and a drive circuit for driving the display.

The operation unit 13 is a unit that receives operations and inputs by the user and can be referred to as an operation reception unit. The operation unit 13 can include a touch panel or touch sensor mounted on the display unit 12. In this case, when the user performs a touch operation on the operation image displayed on the display unit 12, the operation unit 13 can receive the operation corresponding to the area where the user performed the touch operation. The display unit 12 that displays an operation image, and the operation unit 13 that includes a touch panel or touch sensor mounted on the display unit 12 can constitute the operation panel of the image forming apparatus 1. In addition, the operation unit 13 may also include a physical button group, for example. Some buttons of the physical button group can be configured to receive the operation on the operation image. Of course, some or all buttons of the physical button group can be configured to receive the operation independent of the operation image.

The communication unit 14 can be one or a plurality of communication interfaces for the image forming apparatus 1 to perform communication with a plurality of external devices via the wired or wireless network N in accordance with a predetermined communication protocol, including a predetermined communication standard. The external device is, for example, a device having a communication function such as a personal computer (PC), a server device, a smartphone, a tablet terminal, or the like. The external device for communication regarding the processing of the operation image includes the external device 2.

The communication unit 14 can transmit, to the external device 2, display information for displaying the operation image on the external device 2 via the network N. The display information may be the operation image itself. Hereinafter, to distinguish the display information from the operation image to be displayed on the display unit 12, the operation image to be displayed on a display unit 22 of the external device 2 based on the display information is hereinafter referred to as a remote operation image. The communication unit 14 can receive an operation event received by the external device 2 from the external device 2 via the network N.

In addition, the communication unit 14 can receive a file to be printed from the external device. The external device that transmits the file to be printed can be an external device other than the external device 2. The communication unit 14 may be configured to receive the file to be printed from the external device 2 via the network N.

The printing unit 15 performs printing on a medium based on, for example, the file to be printed received from an external device other than the external device 2 or the external device 2 via the communication unit 14, or the file to be printed that has been image read by a scanner (not shown). This forms the image indicated by the file to be printed on that media. Various printing methods such as an ink jet printing method and a laser printing method can be applied in the printing method in the printing unit 15. The image forming apparatus 1 can be referred to as an ink jet printer when adopting an ink jet printing method, and can be referred to as a laser printer when adopting a laser printing method.

### Schematic Configuration of External Device 2

The external device 2 can be a device having a communication function such as a smartphone, a tablet terminal, or a PC. The external device 2 is not limited to a portable device, but can be an installed device. External device 2 can be referred to as a terminal device. As illustrated in FIG. 1, the external device 2 can include a control unit 20, a storage unit 21, the display unit 22, an operation unit 23, and a communication unit 24.

The control unit 20 of the external device 2 controls the entire external device 2. The control unit 20 can include a reception processing unit 20a and a transmission processing unit 20b, the details of which are described below.

The control unit 20 can include, for example, an arithmetic processing unit such as a CPU or GPU, a working memory, and a storage device that stores a control program, a parameter, and the like. The control unit 20 can be configured as an SoC. As can be seen from these examples, the control unit 20 can be configured to store the control programs in an executable state. The control unit 20 can be a configuration that stores a control program as a circuit configuration such as an FPGA, or may be a configuration as a dedicated circuit. The reception processing unit 20a and the transmission processing unit 20b can be implemented as the programs described above. The above program can be a program to implement the functions of the reception processing unit 20a and the transmission processing unit 20b in cooperation with the storage unit 21, the display unit 22, the operation unit 23, and the communication unit 24.

The storage unit 21 includes, for example, a hard disk drive, solid state drive, or another memory. Part of the memory provided by the control unit 20 may be considered as the storage unit 21. The storage unit 21 can be regarded as part of the control unit 20.

The display unit 22 is a unit for displaying information. The display unit 22 can display the remote operation image provided by the image forming apparatus 1 as at least part of the information. The display unit 22 is configured by a display device, such as a liquid crystal display or an organic EL display. The display unit 22 can be configured to include a display and a drive circuit for driving the display.

The operation unit 23 is a unit that receives operations and inputs by the user and can be referred to as an operation reception unit. The operation unit 23 can receive the operation on the remote operation image displayed on the display unit 22. The operation unit 23 can be implemented by one or a plurality of, for example, a physical button, a touch panel or a touch sensor mounted on the display unit 22, a pointing device, and a keyboard. A configuration where the operation unit 23 includes a touch panel or touch sensor may be referred to as an operation panel of the external device 2 including the display unit 22 and a touch panel.

The communication unit 24 can be one or a plurality of communication interfaces for the external device 2 to perform communication with one or a plurality of external devices via the wired or wireless network N in accordance with a predetermined communication protocol, including a predetermined communication standard. The external device for communication regarding the processing of the operation image includes the image forming apparatus 1.

The communication unit 24 can receive, from the image forming apparatus 1 via the network N, display information for displaying the remote operation image on the display unit 22 of the external device 2. As mentioned above, the display information may be the remote operation image itself. The communication unit 24 can transmit the operation event received by the operation unit 23 to the image forming apparatus 1 via the network N. In addition, the communication unit 24 may be configured to transmit the file to be printed to the image forming apparatus 1 via the network N.

### Specific Configuration of System 100

Details of the control unit 10 of the image forming apparatus 1 is described, along with details of the external device 2. In a system 100, as a schematic flow, the external device 2 accesses the image forming apparatus 1 via the network N to receive display information based on the operation image displayed on the display unit 12 of the image forming apparatus 1, and displays the remote operation image on the display unit 22 based on the display information. In the system 100, the remote operation image is an image that has been subjected to a personal information protection process.

The external device 2 then receives a user operation on the remote operation image at the operation unit 23 and transmits an operation event indicating the user operation to the image forming apparatus 1 via the network N. The image forming apparatus 1 can receive an operation of the operation image based on the received operation event and thereby execute the process indicated by the operation event. For example, based on the operation event, the image forming apparatus 1 can change the current operation image and the current remote operation image by transition or the like to the next operation image and the next remote operation image, respectively.

First, a configuration example of the image forming apparatus 1 is described. As described above, the control unit 10 of the image forming apparatus 1 can include the transmission processing unit 10a, the reception processing unit 10b, and the switching unit 10c.

The transmission processing unit 10a transmits the display information based on the operation image displayed on the display unit 12 to the external device 2 via the communication unit 14. Such transmission of display information by the transmission processing unit 10a is performed via network N. The display information can be referred to as screen information since the display information is information displayed on the screen of the display unit 12. The display information is information for displaying the remote operation image on the display unit 22 of the external device 2. The display information can be displayed on the display unit 22 of the external device 2 using, for example, a Web browser, in which case the display information can be referred to as Web screen information. As in this example, the transmission processing unit 10a may transmit the display information as information to be displayed on the browser of the external device 2.

The reception processing unit 10b can be configured to receive, from the external device 2, the operation event received by the external device 2 via the communication unit 14. Receipt of such an operation event by the reception processing unit 10b is performed via the network N. The operation event is an event indicating an operation received via the remote operation image displayed based on the display information transmitted to the external device 2.

By transmitting such display information and receiving the operation event by the transmission processing unit 10a and the reception processing unit 10b, respectively, the image forming apparatus 1 includes the function of providing an operation panel remotely to the external device 2, that is, includes the function of providing a remote panel. However, the operation of the operation image by the operation event is not mandatory in the present embodiment. In the system 100, the system excluding the processing related to such an operation is a system having a function of remotely monitoring the operation image displayed on the display unit 12 of the image forming apparatus 1 among the functions of the remote panel.

The switching unit 10c switches the disclosure mode regarding information disclosure in the remote operation image. The disclosure mode includes the first mode and the second mode. In other words, the switching unit 10c can switch the disclosure mode between at least the first mode and the second mode. The disclosure mode can be referred to as a protection mode since it is a mode related to the protection of information.

The first mode is a mode in which the prescribed information included in part of the operation image is included in the display information used to display the remote operation image, and the registration information 11a included in part of the operation image is included in the display information used to display the remote operation image. The first mode can be referred to as a public mode since both the prescribed information and the registration information 11a are included in the remote operation image and disclosed to the external device 2.

The prescribed information can be, for example, information that is included in the operation image by default. To take a more specific example, the prescribed information is information that is preset when the image forming apparatus 1 is shipped from the factory or dealer, that is, information that is not customized by the user, and can include, for example, a default icon image and a default background image. The prescribed information may include, for example, contact information about the maintenance contact of the image forming apparatus 1. The maintenance contact here may be a contact of the remote operator who displays the remote operation image on the external device 2.

The prescribed information is only required to be included in part of the operation image and need not be included in the whole of the operation image to be displayed on the display unit 12. The operation image that does not include the prescribed information may not be subject to processing in the first mode, as well as in the second mode and the third mode described below, but may be included in the display information for displaying the remote operation image.

The registration information 11a is information registered in the image forming apparatus 1 by the user, as described above. The registration information 11a can include contact information indicating a contact registered by user input, user setting information, and the like The user setting information may include information indicating an icon image or a background image customized by the user, a password registered by the user, and the like. The registration information 11a may be, for example, information that has been registered after part of the prescribed information has been changed by the user. The registration information 11a is only required to be included in part of the operation image, and need not be included in the whole of the operation image to be displayed on the display unit 12.

The second mode is a mode in which the above-mentioned prescribed information is included in the display information and the above-mentioned registration information 11a is not included in the display information. The second mode can be referred to as a semi-public mode since the prescribed information is included in the remote operation image and disclosed to the external device 2, while the registration information 11a is not included in the remote operation information and is not disclosed to the external device 2.

When the switching unit 10c switches the disclosure mode between the first mode and the second mode in this manner, the default mode can be the second mode. In other words, the switching unit 10c should set the disclosure mode to the second mode when the transmission processing unit 10a starts transmitting the display information. This allows the remote panel to start in the second mode, where information is more protected.

The disclosure mode may further include a third mode in which the prescribed information is not included in the display information and the registration information 11a is not included in the display information. In other words, the switching unit 10c may be able to switch the disclosure mode between at least the first mode, the second mode, and the third mode. The third mode can be referred to as a private mode.

When the switching unit 10c switches the disclosure mode between the first mode, the second mode, and the third mode in this manner, the default mode can be the third mode. In other words, the switching unit 10c should set the disclosure mode to the third mode when the transmission processing unit 10a starts transmitting the display information. This allows the remote panel to start in the third mode that provides the most information protection of the three modes.

Next, a configuration example of the external device 2 is described. As mentioned above, the control unit 20 of the external device 2 can include the reception processing unit 20a and the transmission processing unit 20b.

The reception processing unit 20a receives display information based on the operation image displayed on the display unit 12 of the image forming apparatus 1 from the image forming apparatus 1 via the communication unit 24. Receipt of such display information by the reception processing unit 20a is performed via the network N. The reception processing unit 20a can be referred to as an acquisition processing unit since it acquires the display information from the image forming apparatus 1.

The display unit 22 then displays the remote operation image based on the display information received by the reception processing unit 20a. As mentioned above, the display information can be displayed on the display unit 22 using, for example, a Web browser. As in this example, the reception processing unit 20a may receive the display information as information to be displayed on the browser of the external device 2.

The transmission processing unit 20b can be configured to transmit the operation event received by the operation unit 23 to the image forming apparatus 1 via the communication unit 24. Transmission of such an operation event by the transmission processing unit 20b is performed via the network N. Examples of the operation event can include, for example, a click operation or a touch operation with a pointing device on a remote operation image displayed on the display unit 22. The pointing device can be referred to as a mouse.

By receiving such display information and transmitting the operation event by the reception processing unit 20a and the transmission processing unit 20b, respectively, the external device 2 includes the function to receive the provision of the operation panel remotely by the image forming apparatus 1, that is, includes the function to receive the remote panel. However, as mentioned above, the operation of the operation image by the operation event is not mandatory in the present embodiment. Processing example of the system 100

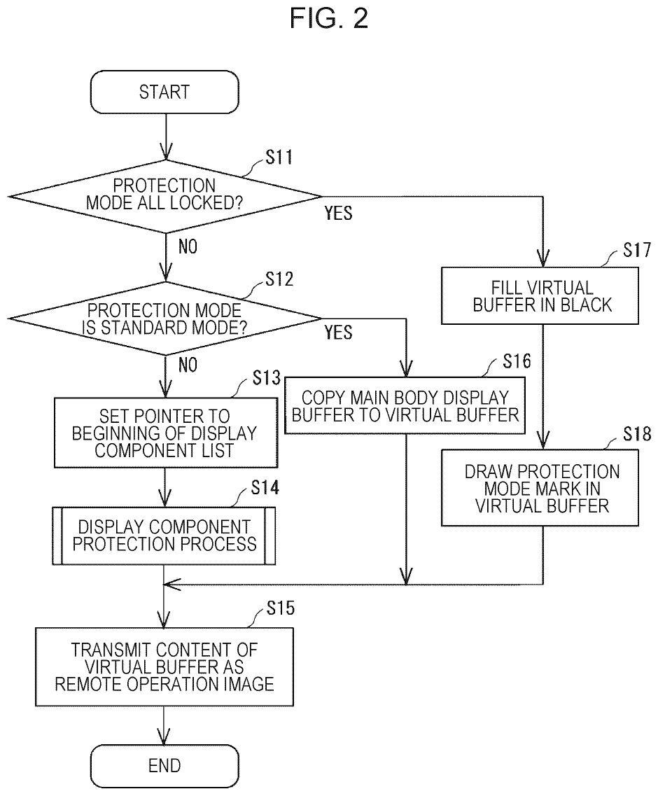

As described above, the configurations of the image forming apparatus 1 and the external device 2 are described. Next, in the above configuration, the process by which the remote operation image is changed according to the disclosure mode is described with specific examples. Here, with reference to FIGS. 2 through 12, the flow of processing of the image forming apparatus 1, including mainly the process of changing such remote operation images, is described. For simplicity of description, an example is described in which the display information transmitted from the image forming apparatus 1 is the remote operation image itself to be displayed on the browser that can be displayed on the display unit 22 of the external device 2. The description of the process of displaying the operation image on the display unit 22 is omitted here.

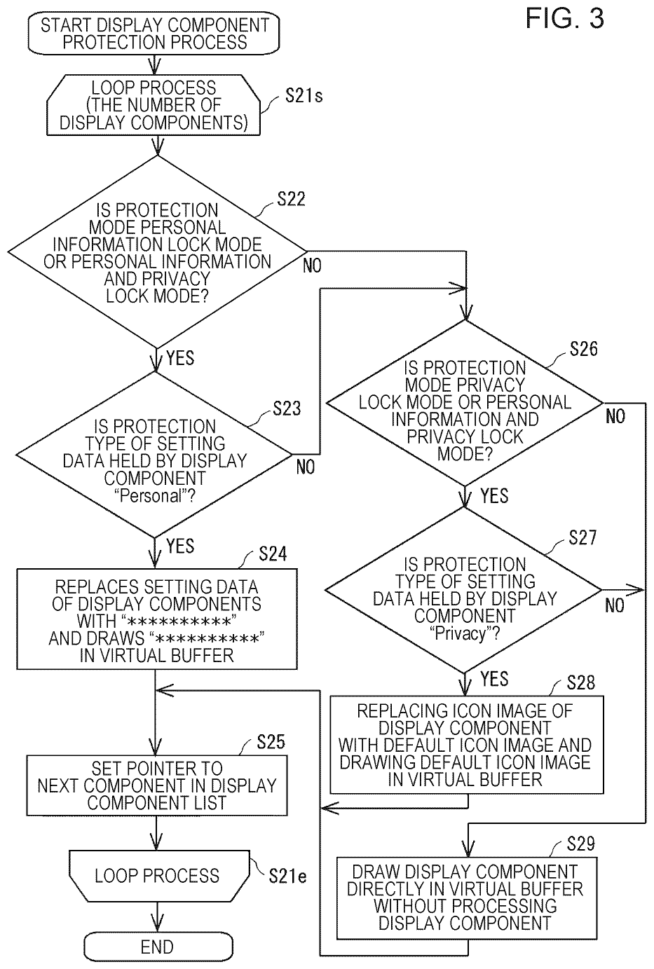

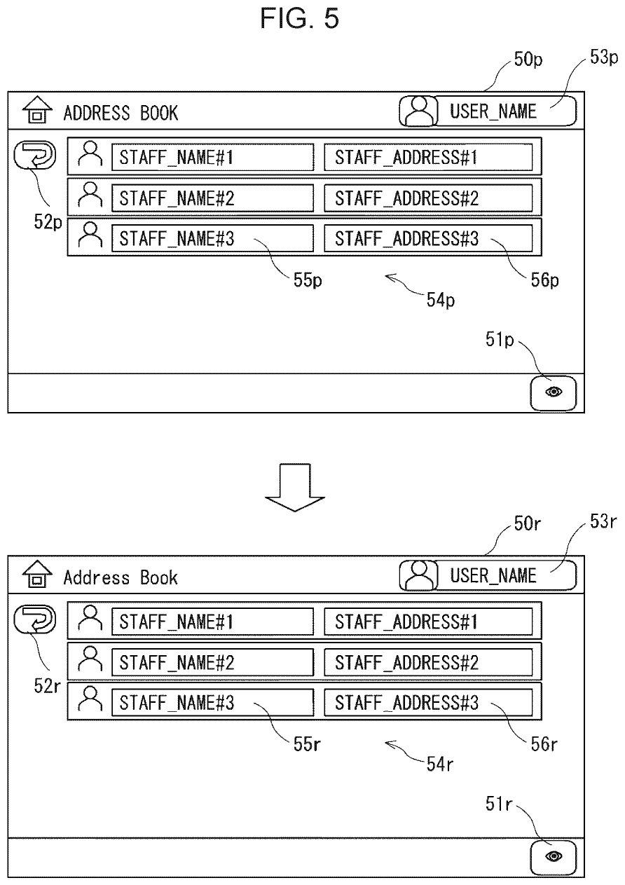

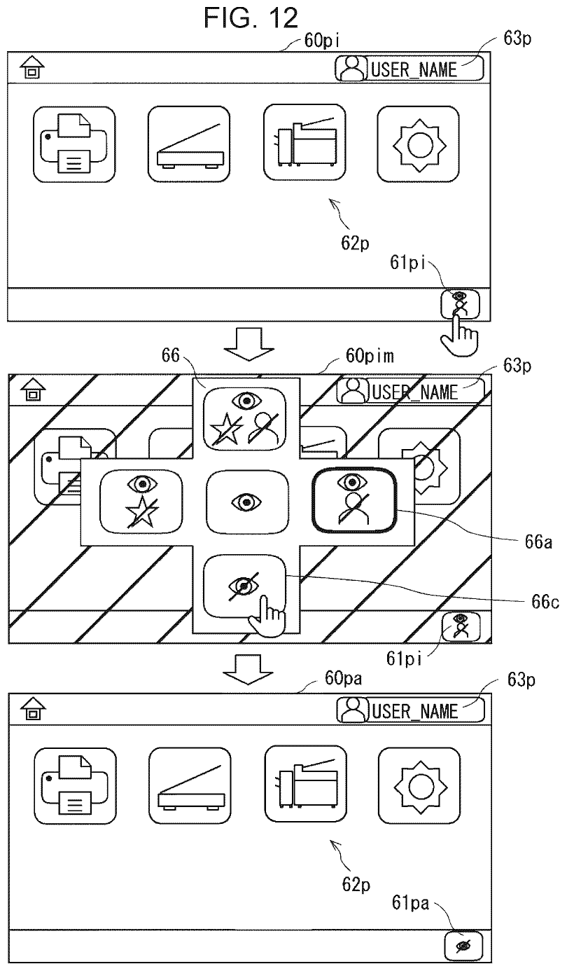

FIG. 2 is a flow diagram for describing a processing example of the image forming apparatus 1 in the system 100. FIG. 3 is a flow diagram for describing an example of the display component protection process in the processing example in FIG. 2. FIG. 4 shows an example of a table to be referenced to in the process of FIG. 2. FIGS. 5 through 11 are schematic diagrams each showing an example of an operation image displayed in the system 100 and an example of a remote operation image displayed corresponding the operation image. FIG. 12 is a schematic diagram showing an example of an operation image displayed in the system 100.

Prior to describing the process flow, an explanation of the disclosure mode is described. When the image forming apparatus 1 starts to provide a remote panel to the external device 2, the image forming apparatus 1 determine the disclosure mode. The disclosure mode is a mode indicating how the information is protected and is referred to as a protection mode in the following. The protection mode can be set in advance by the operation unit 13 and can be changed as needed.

The first mode described above is a mode in which information is not protected and is referred to as a standard mode in the following. In the standard mode, the entire operation image is disclosed as it is as the remote operation image to the user of the external device 2 who is the remote operator.

The second mode described above is a mode in which the prescribed information is included in the remote operation image and the registration information 11a is not included in the remote operation image, but can include a plurality of modes depending on the type of registration information 11a. For example, the second mode can include a personal information lock mode, a privacy lock mode, and a personal information and privacy lock mode, and the description is made in the following with such examples.

The personal information lock mode refers to a mode in which the personal information represented by contact information in the registration information 11a is not included in the remote operation image. In addition, the personal information lock mode is a mode in which the prescribed information is included in the remote operation image. In the personal information lock mode, the remote operation image is provided to the user of the external device 2 with the personal information, such as a contact in the address book, made private.

The privacy lock mode refers to a mode in which the prescribed information is included in the remote operation image and privacy information, such as the user's personal preferences, and the like, in the registration information 11a is not included in the remote operation image. In the privacy lock mode, a remote operation image with a background image or an icon image customized by a user who is the administrator of the image forming apparatus 1, for example, the owner of the image forming apparatus 1, kept private is provided to the user of the external device 2. For example, the privacy lock mode can be a default protection mode when starting the process of providing the remote operation image to the external device 2. Of course, the default protection mode may be a mode other than privacy lock mode, such as personal information lock mode.

The personal information and privacy lock mode is a mode in which the prescribed information is disclose, and the information to be kept private in both the personal information lock mode and the privacy lock mode is kept private. Therefore, in the personal information and privacy lock mode, the prescribed information is included in the remote operation image, and the background image and the icon image that are customized and personal information such as a contact are not be included in the remote operation image.

The third mode, described above, is a mode in which both the prescribed information and the registration information 11a are protected, and is referred to as an all-lock mode. In the all-lock mode, the remote operation image with information included in the basically entire operation image kept private is provided to the user of the external device 2.

Hereinafter, the process flow is described. First, the transmission processing unit 10a determines whether the current protection mode is the all-lock mode (step S11). When information indicating the current protection mode is stored in the storage unit 11, the transmission processing unit 10a can read the information to make the determination. When NO in step S11, the transmission processing unit 10a determines whether the current protection mode is the standard mode (step S12).

When YES in step S12, that is, when the current protection mode is the standard mode, the transmission processing unit 10a copies a main body display buffer to a virtual buffer (step S16). The main body display buffer is a buffer set in, for example, the internal memory of the control unit 10 the buffer for drawing the operation image. The display unit 12 can display the operation image stored in the main body display buffer. The virtual buffer is a buffer for drawing the remote operation image, the buffer being set in the internal memory of the control unit 10. Next, the transmission processing unit 10a transmits the remote operation image stored in the virtual buffer to the external device 2 (step S15) and terminates the process.

For example, in a scene where an operation image 50p shown in FIG. 5 is displayed on the display unit 12, in step S15 after the processing in step S16, a remote operation image 50r, shown in FIG. 5, that is a copy of the operation image 50p as it is transmitted to the external device 2. The reception processing unit 20a of the external device 2 then receives the remote operation image 50r and display the remote operation image 50r on the display unit 22.

The operation image 50p is an example of an operation image displayed on the display unit 12 in the standard mode. The operation image 50p includes a mark 51p indicating the current protection mode, a return button 52p to return to the previous operation image, information 53p indicating the name of the user of the image forming apparatus 1, and contact information 54p. The contact information 54p includes information 55p indicating the name of the person or the name of the organization of the contact and information 56p indicating the e-mail address corresponding to the each name.

Since the example shows that the current protection mode is the standard mode, the mark 51p is a predetermined mark corresponding to the standard mode. The mark 51p may be a mode switching button that can be pressed to change to another protection mode. This is true for other operation images described below. An example of the operation for switching the protection mode using the mode switching button is described below.

The remote operation image 50r is an example of a remote operation image that is transmitted to the external device 2 and displayed on the display unit 22 corresponding to the operation image 50p. The remote operation image 50r includes a mark 51r, a return button 52r, information 53r, contact information 54r including information 55r and 56r, corresponding to the mark 51p, the return button 52p, the information 53p, the contact information 54p including the information 55p and 56p, respectively. However, even when the mark 51p is a mode switching button, the mark 51r is not a mode switching button but simply a mark indicating the current protection mode. This is true for other remote operation images discussed below.

On the other hand, if YES in step S11, that is, when the current protection mode is the all-lock mode, the transmission processing unit 10a fills the virtual buffer in black color (step S17). Another color may be used in place of black. Next, the transmission processing unit 10a draws a protection mode mark, which is a mark indicating the current protection mode, in the virtual buffer (step S18). The transmission processing unit 10a then transmits the content of the virtual buffer to the external device 2 as a remote operation image (step S15) and terminates the process.

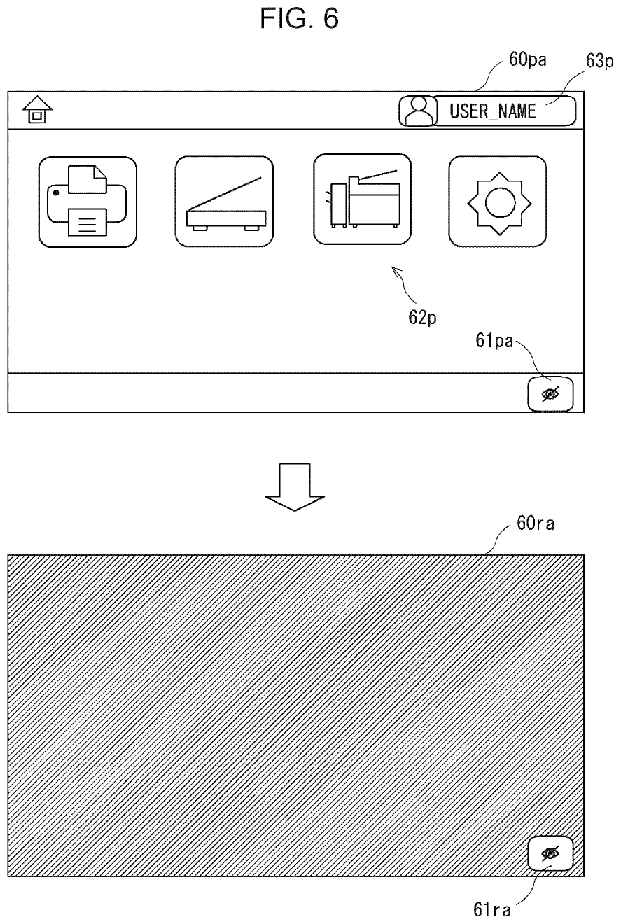

For example, in a scene where an operation image 60pa shown in FIG. 6 is displayed on the display unit 12, in step S15 after the process of step S18, a remote operation image 60ra shown in FIG. 6 is transmitted to the external device 2. The reception processing unit 20a of the external device 2 then receives the remote operation image 60r and display the remote operation image 60r on the display unit 22.

The operation image 60pa is an example of an operation image displayed on the display unit 12 in the all-lock mode. The operation image 60pa includes a predetermined mark 61pa corresponding the all-lock mode that is the current protection mode, an icon group 62p including a plurality of icon images, and information 63p indicating the name of the user of the image forming apparatus 1. The icon group 62p includes the icon image indicating each of the print function, the scanner function, the copy function, and the setting function that can be selected by the image forming apparatus 1. Although not shown in the figure, in a scene where the operation image similar to the operation image 60pa is displayed in the standard mode, the mark 61pa is simply replaced for the standard mode, and the operation image with the same icon group 62p and the same information 63p is displayed.

The remote operation image 60ra is an example of a remote operation image, corresponding to the operation image 60pa, that is transmitted to the external device 2 and displayed on the display unit 22. The remote operation image 60ra is an image in which a mark 61ra is drawn as a protection mode mark in the image filled in black. The mark 61ra is a mark corresponding to the mark 61pa. Thus, the remote operation image 60ra is an image that corresponds to the operation image 60pa but that in in the all-lock mode, resulting in an image with only the image size and the protection mode mark same as those of the operation image 60pa.

When NO in step S12, that is, when the current protection mode is any of the second modes, the transmission processing unit 10a sets a pointer to the beginning of a display component list of the remote operation image (step S13). The display component list of the remote operation image refers to a list of a plurality of display components that constitutes the remote operation image. The display component can be referred to as an object. The plurality of display components that constitutes the remote operation image can be components corresponding to the plurality of display components that constitutes the operation image to be displayed on the display unit 12. However, the definition of display components may be determined in any manner. The display component may be defined individually according to the type of display component, for example, whether the display component is an icon image or an information display frame. The pointer refers to an address of the storage area, in the internal memory of the control unit 10, that is set to draw the individual display components of the remote operation image to be transmitted to the external device 2. In step S13, the pointer is set in the internal memory as information indicating the beginning of the display component list.

Following step S13, the transmission processing unit 10a executes the protection process on the display component indicated by the pointer (step S14). Hereinafter, the protection process is hereinafter referred to as a display component protection process.

As shown in FIG. 3, the display component protection process can be a loop process in which the process shown in steps S22 to S29 is executed until the process is finished for all display components in the display component list (steps S21s and S21e). In other words, the loop process is repeated by the number of display components.

In the loop process, the transmission processing unit 10a first determines whether the current protection mode is personal information lock mode or the personal information and privacy lock mode (step S22). In step S22, it is determined whether the mode is a mode in which the personal information is protected. When NO in step S22, the transmission processing unit 10a determines whether the current protection mode is the privacy lock mode or the personal information and privacy lock mode (step S26). In step S26, it is determined whether the mode is a mode in which the privacy information is protected.

When YES in step S22, that is, when the current protection mode is a mode in which the personal information is protected, the transmission processing unit 10a determines whether the protection type of the setting data held by the target display component is “Personal” (step S23). The setting data here refers to data that is set to be included in the target display component. For example, when the display component is configured by a character string and a frame surrounding the character string, the setting data would be data indicating the character string. Examples of the character string can include, for example, a contact name and an e-mail address. When NO in step S23, the transmission processing unit 10a executes the process in step S26.

For example, in determination in step S23, protection setting information such as the table 11b shown in FIG. 4 can be used. The protection setting information, such as the table 11b, can be stored in the storage unit 11. The protection setting information, such as the table 11b, can be set in advance from the operation unit 13 and can be changed as needed.

In the table 11b, “Data” that indicates an individual display component is set in association with “Data Type” that is its data type and “Protection Type” that is its protection type. In the table 11b, each “Data” can be classified and recorded, for example, into “Category1”, which is a large category, and “Category2”, which is a smaller and more detailed category.

The table 11b includes a plurality of contacts as display components, such as respective items of the contact “Address1” in the contact information. Examples of the item of the contact include “User Name”, “Mail Address”, and “Phone Number”, which indicate the name of the person or the name of the organization of the contact, the e-mail address, and the phone number, respectively. The table 11b includes, as display components, “Time”, “Date”, and “Language” that indicate the current time, the current date, and the language used, respectively, classified into the basic settings of the image forming apparatus 1. The table 11b includes, as display components, “Function Icon” and “Home BG” that indicate the function icon and the background image of the home screen, respectively, classified into the custom settings of the image forming apparatus 1. The table 11b includes, as display components, “IP Address” and “Subnet Mask” that indicate the internet protocol (IP) and the subnet mask, respectively, classified into the network settings of the image forming apparatus 1.

In the table 11b, the data type corresponding to each “Data” is set as a “Data Type” from among, for example, “String (MultiByte)”, “String (ASCII)”, “Integer”, and “Image (Binary)”.

In the table 11b, the protection type corresponding to each “Data” is set as “Protection Type” from among “Personal” that indicates that the personal information is protected, “Normal” that indicates that protection is not provide, and “Privacy” that indicates that the privacy information is protected. “Data” set to “Personal” indicates that the display component is a display component for which the personal information is protected. “Data” set to “Normal” indicates that the display component is a display component for which the protect the personal information and the privacy information are not protected unless the mode is the all-lock mode. “Data” set to “Privacy” indicates that the display component is a display component for which the privacy information is protected.

In addition, the table 11b includes, as a setting other than the display component, “Default Protection Mode” that indicates the default protection mode classified into the security settings of the image forming apparatus 1. Here is an example is described in which the protection mode is set to “Personal” that indicates the personal information lock mode. The protection mode can be set from among “All” that indicates the all-lock mode, “Privacy” that indicates the privacy lock mode, and “Personal and Privacy” that indicates the personal information and privacy lock mode in addition to “Personal”. The determination in steps S11, S12, S22, and S26 above can be made with reference to the settings.

When YES in step S23, that is, when the target display component is a display component for which the personal information is protected, the transmission processing unit 10a replaces the setting data of the target display component with a predetermined character string and draws the predetermined character string in the virtual buffer (step S24). Hereinafter, an example is described in which “**********” is used as a predetermined character string. The predetermined character string is only required to be a character string that indicates that the character string that should be displayed in the area when not protected is hidden.

Next, the transmission processing unit 10a sets the pointer to the next display component (step S25) and executes the process in step S22.

When YES in step S26, that is, when the current protection mode is a mode in which the privacy information is protected, the transmission processing unit 10a determines whether the protection type of the setting data held by the target display component is “Privacy” (step S27). The table 11b can be used for the determination in step S27.

When NO in step S27, the transmission processing unit 10a draws the target display component in the virtual buffer as it is without processing (step S29) and advances the process to step S25. In step S29, the display component in the operation image is drawn in the virtual buffer. When NO in step S26, the process proceeds to step S29.

When YES in step S27, that is, when the target display component is a display component for which the privacy information is protected, the transmission processing unit 10a replaces the icon image of the target display component with the default icon image and draws the default icon image in the virtual buffer (step S28). After step S28, the process proceeds to step S25.

After the display component protection process described above, the transmission processing unit 10a transmits the content of the virtual buffer to the external device 2 as a remote operation image (step S15), and terminates the process. With such a display component protection process, the remote operation image transmitted to the external device 2 is an image for which information is protected for the operation image, as exemplified in (1) through (4) below, for example.

### (1) Example of Remote Operation Image in Personal Information Lock Mode

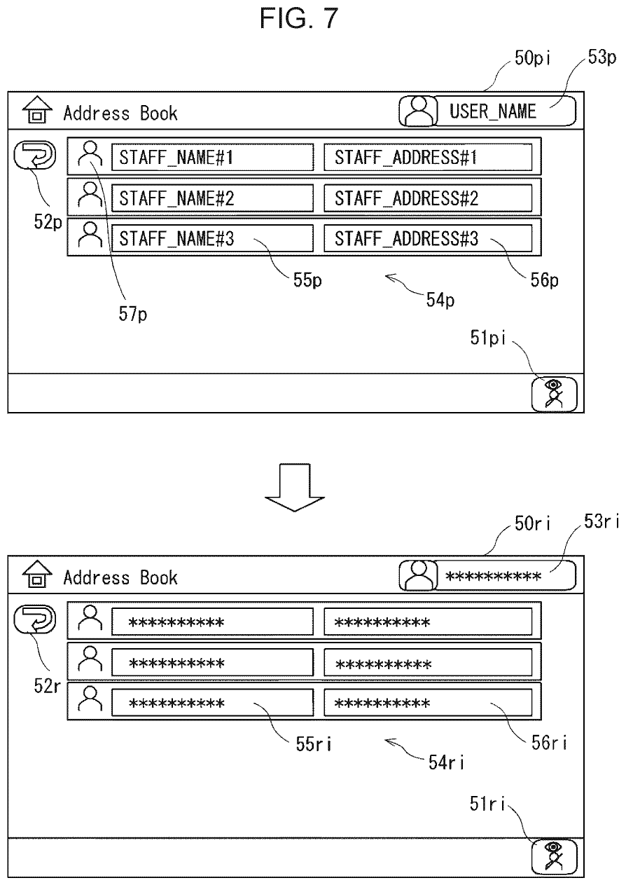

For example, in a scene where an operation image 50pi shown in FIG. 7 is displayed on the display unit 12, in step S15 after the process of step S24, a remote operation image 50ri with the personal information made private is transmitted to the external device 2. The reception processing unit 20a of the external device 2 then receives the remote operation image 50ri and display the remote operation image 50ri on the display unit 22.

The operation image 50pi is an example of an operation image displayed on the display unit 12 in the personal information lock mode. The operation image 50pi is an image in which the mark 51p indicating the standard mode is replaced with a mark 51pi indicating the personal information lock mode in the operation image 50p in FIG. 5.

The remote operation image 50ri is an image in which the information 53p indicating the user name, the information 55p indicating the contact name, and the information 56p indicating the e-mail address, as display components, in the operation image 50pi are all replaced with “**********”. It can be seen that the information 53p, and the contact information 54p including the information 55p and 56p in the operation image 50pi is replaced with information 53ri, and contact information 54ri including information 55ri and 56ri in the remote operation image 50ri, respectively. The remote operation image 50ri includes a mark 51ri indicating the personal information lock mode, the mark 51ri being the same as the mark 51pi.

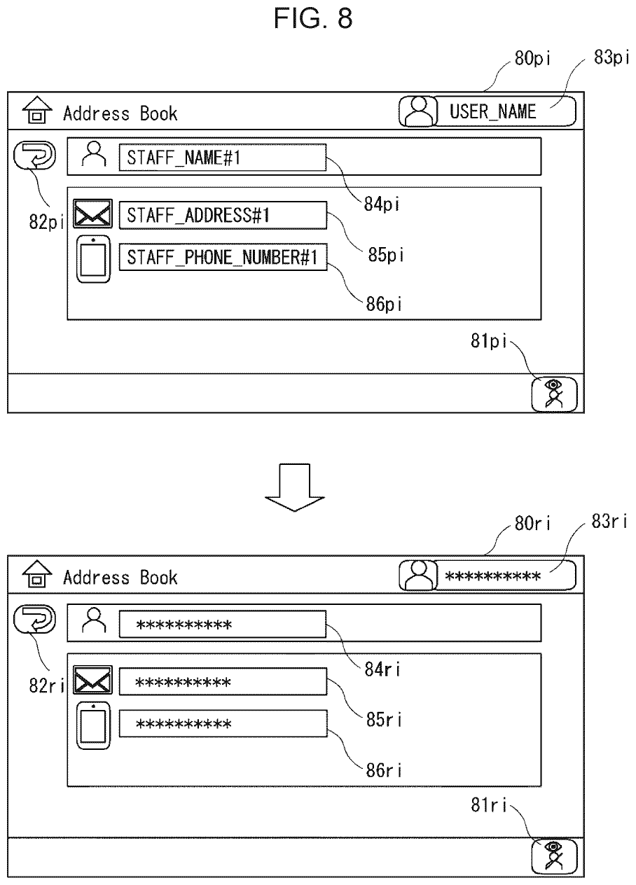

When a mark 57p included in the contact information 54p in the operation image 50pi is selected by the operation unit 13 from the state shown in FIG. 7, an operation image 80pi and a remote operation image 80ri shown in FIG. 8 can be displayed on the display unit 12 and the display unit 22, respectively. The remote operation image 50ri may be provided so that such a display can be performed by a selection operation from the operation unit 23 on the remote operation image 50ri. However, even in this case, the result is that the operation image 80pi and the remote operation image 80ri are displayed on the display unit 12 and the display unit 22, respectively.

The operation image 80pi is an example of an operation image displayed on the display unit 12 in the personal information lock mode. The operation image 80pi includes a mark 81pi indicating the current protection mode, a return button 82pi, information 83pi indicating the user name, and information about the contact indicated by the mark 57p. The information about the contact includes information 84pi indicating the name, information 85pi indicating the e-mail address, and information 86pi indicating the phone number.

The remote operation image 80ri is an example of a remote operation image, corresponding to the operation image 80pi, that is transmitted to the external device 2 and displayed on the display unit 22. The remote operation image 80ri includes a mark 81ri, a return button 82ri, information 83ri, information 84ri, information 85ri, and information 86ri corresponding to the mark 81pi, the return button 82pi, the information 83pi, the information 84pi, the information 85pi, and the information 86pi, respectively. It can be seen that in the information 83ri, 84ri, 85ri, and 86ri, the information in the corresponding operation image 80pi is replaced with “**********”. The remote operation image 80ri includes the mark 81ri indicating the personal information lock mode, the mark 81ri being the same as the mark 81pi.

### (2) Example of Remote Operation Image in Privacy Lock Mode

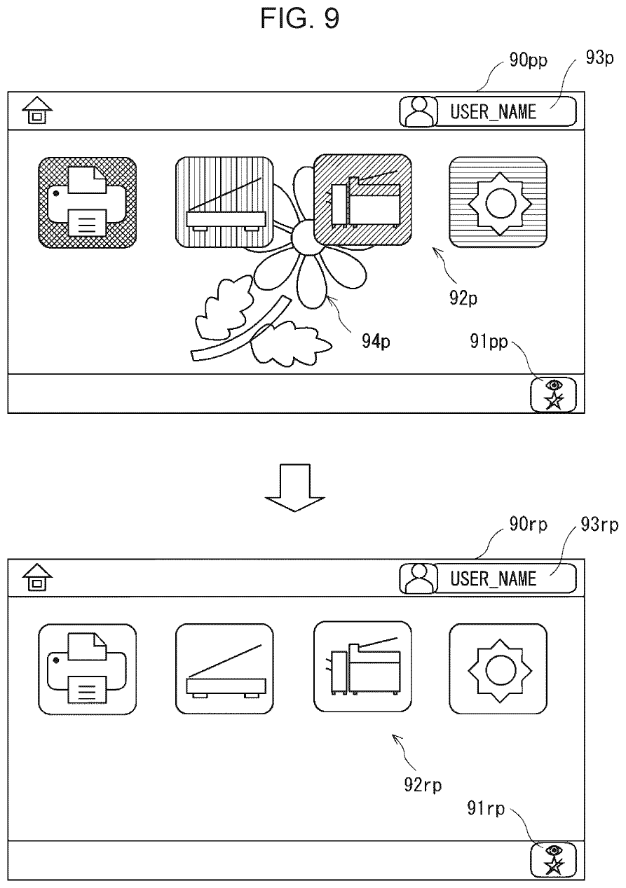

For example, in a scene where an operation image 90pp shown in FIG. 9 is displayed on the display unit 12, in step S15 after the process of step S28, a remote operation image 90rp with the privacy information made private is transmitted to the external device 2. The reception processing unit 20a of the external device 2 then receives the remote operation image 90rp and display the remote operation image 90rp on the display unit 22.

The operation image 90pp is an example of an operation image displayed on the display unit 12 in the privacy lock mode. The operation image 90pp includes a predetermined mark 91pp corresponding to the privacy lock mode that is the current protection mode, an icon group 92p including a plurality of customized icon images, information 93p indicating the name of the user of the image forming apparatus 1, and a background image 94p. In the icon group 92p, an example is described in which different customizations are made for respective icons, but the same customization may be made for respective icons, such as the same color for respective icons. Although not shown in the figure, in a scene where the operation image similar to the operation image 90pp is displayed in the standard mode, the mark 91pp is simply replaced for the standard mode, and the operation image with the same icon group 92p and the same information 93p is displayed.

The remote operation image 90RP is an example of a remote operation image, corresponding to the operation image 90PP, that is transmitted to the external device 2 and displayed on the display unit 22. The remote operation image 90rp is an image in which the icon group 92p in the operation image 90pp is replaced with a pre-customized icon group 92rp and the background image 94p is deleted or replaced with a pre-customized white background image. The remote operation image 90rp includes a mark 91rp and information 93rp that are the same as the mark 91pp and the information 93p, respectively.

### (3) First Example of Remote Operation Image in Personal Information and Privacy Lock Mode

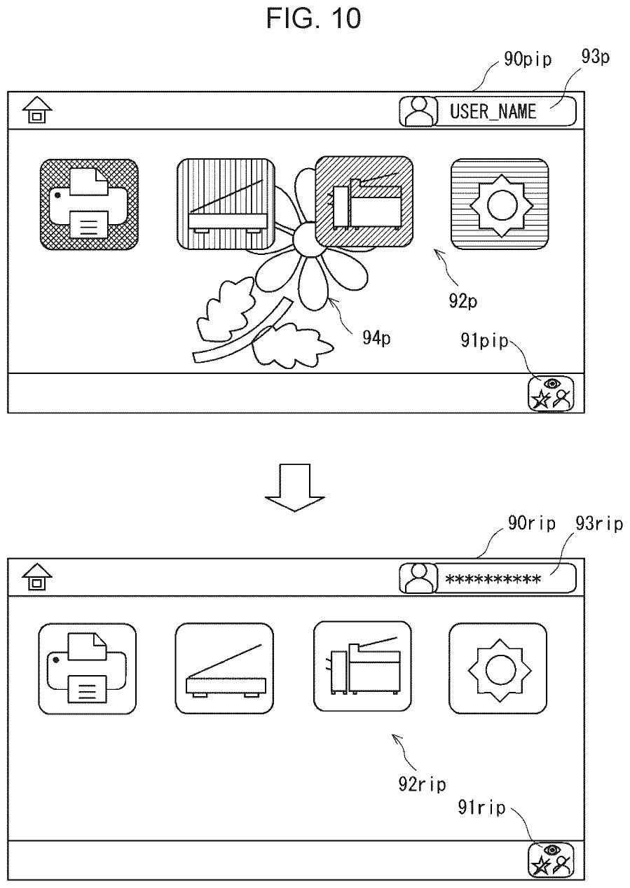

For example, in a scene where an operation image 90pip shown in FIG. 10 is displayed on the display unit 12, in step S15 after the process of steps S24 and S28, a remote operation image 90rip with the personal information and the privacy information made private is transmitted to the external device 2. The reception processing unit 20a of the external device 2 then receives the remote operation image 90rip and display the remote operation image 90rip on the display unit 22.

The operation image 90pip is a first example of an operation image displayed on the display unit 12 in the personal information and privacy lock mode. The operation image 90pip includes the predetermined mark 91pp corresponding to the personal information and privacy lock mode that is the current protection mode, the icon group 92p including a plurality of customized icon images, the information 93p indicating the name of the user of the image forming apparatus 1, and the background image 94p.

The remote operation image 90rip is a first example of a remote operation image, corresponding to the operation image 90pip, that is transmitted to the external device 2 and displayed on the display unit 22. The remote operation image 90rip is an image where the icon group 92p in the operation image 90pip is replaced with a pre-customized icon group 92rip and the background image 94p is deleted or replaced with a pre-customized white background image. The icon group 92rip is the same as the icon group 92rp in FIG. 9. Furthermore, the remote operation image 90rip is an image in which the information 93p in the operation image 90pip is replaced with information 93rip indicating “**********”. The remote operation image 90rip includes a mark 91rip that is the same as the mark 91pip.

### (4) Second Example of Remote Operation Image in Personal Information and Privacy Lock Mode

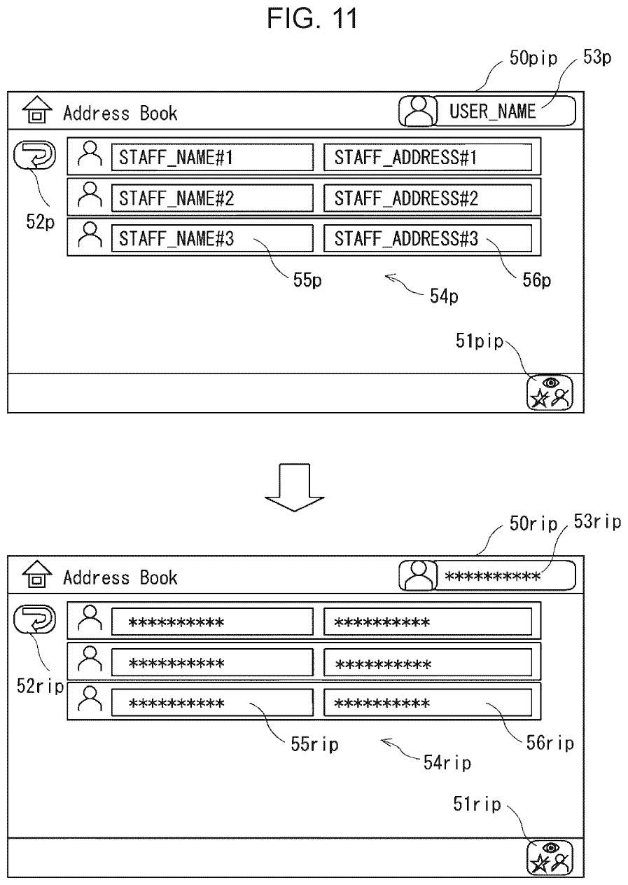

For example, in a scene where an operation image 50pip shown in FIG. 11 is displayed on the display unit 12, in step S15 after the process of step S24, a remote operation image 50rip with the personal information and the privacy information made private is transmitted to the external device 2. The reception processing unit 20a of the external device 2 then receives the remote operation image 50rip and display the remote operation image 50rip on the display unit 22. Since the operation image 50pip does not include the privacy information, the process does not go through step S28. Therefore, the remote operation image 50rip is an image in which only the personal information in the operation image 50pip is made private.

The operation image 50pip is a second example of an operation image displayed on the display unit 12 in the personal information and privacy lock mode. Operation image 50pip is an image in which the mark 51p indicating the standard mode in the operation image 50p in FIG. 5 is replaced with a mark 51pip indicating the personal information and privacy lock mode.

The remote operation image 50rip is a second example of a remote operation image, corresponding to the operation image 50pip, that is transmitted to the external device 2 and displayed on the display unit 22. The remote operation image 50rip includes a return button 52rip, information 53rip, and contact information 54rip including information 55rip and 56rip. It can be seen that in the information 53rip, 55rip, and 56rip, the information of the corresponding operation image 50pip is replaced with “**********”. The remote operation image 50rip includes a mark 51rip indicating the personal information and privacy lock mode, the mark 51rip being the same as the mark 51pip. The remote operation image 50rip corresponds to an image in which the mark 51ri indicating the standard mode in the remote operation image 50ri in FIG. 5 is replaced with the mark 51rip indicating the personal information and privacy lock mode.

As described above, the processing example in FIGS. 2 and 3 is described with examples of the operation image and the remote operation image. However, the processing example in FIGS. 2 and 3 is only an example. For example, the order of determining the protection mode can be changed, and processing can be applied accordingly.

Next, an example of the process of receiving the operation of switching the protection mode is described with reference to FIG. 12. FIG. 12 shows an example of an operation image displayed in the system 100 in the personal information lock mode, an example of an operation image for changing the setting from the operation image to the all-lock mode, and an example of an operation image in the all-lock mode after the change.

An operation image 60pi shown in FIG. 12 is an image in which the mark 61pa in the operation image 60pa of FIG. 6 is replaced with a mode switching button 61pi indicating the personal information lock mode. Here, the mode switching button 61pi is selectable from the operation unit 13 to function as a button that can switch the protection mode. Thus, the operation image displayed on the display unit 12 can include a mode switching button for switching the protection mode. In the following, the protection mode switching operation from such an operation image 60pi is described. As can be seen from the fact that the mark indicating the protection mode is illustrated in the operation image in each of FIGS. 5 through 11, the mode switching button can be included in the operation image displayed on the display unit 12, regardless of which mode the protection mode is or which scene the operation image is an image of.

When the mode switching button 61pi included in the operation image 60pi is selected from the operation unit 13, the switching unit 10c displays an operation image, on the display unit 12, in which the protection mode to which the image is switched, such as, for example, an operation image 60pim, can be selected. Since the operation unit 13 includes a touch sensor or touch panel, the selection of the mode switching button 61pi from the operation unit 13 can be received by touching the mode switching button 61pi.

The operation image 60pim is an image obtained by covering the entire operation image 60pi by an image of a light color, such as gray, with α-blended, and superimposing a mode selection image 66 on the image. The mode selection image 66 includes buttons for all selectable protection modes, with each selectable. The mode selection image 66 in FIG. 12 is a cross key image with the standard mode button in the center and buttons for other modes above, below, left, and right of the standard mode button. In the mode selection image 66, for example, a selection area 66a of the personal information lock mode may be highlighted with a frame surrounding the area so that the user recognizes the current protection mode.

From this state, when the user selects the all-lock mode from the operation unit 13 by, for example, touching a button 66c, the switching unit 10c switches the mode to the all-lock mode, updates the table 11b, and displays the operation image 60pa on the display unit 12 that is illustrated in FIG. 6. The operation image 60pa includes a mode switching button 61pa indicating the all-lock mode.

The touch operation for shifting the mode selection image 66 from the personal information lock mode to the all-lock mode may be received by a single tap or by a long press with a short detection time. In this case, display such as a warning image or other indications for checking the change in protection mode need not be displayed. This is because the touch operation is an operation that makes the information more protected.

Conversely, the touch operation for shifting the mode selection image 66 from the personal information lock mode to the standard mode may be received by a double tap or by a long press that requires a longer detection time. Requiring a longer detection time means that the operation is not received as a touch operation unless the button is touched for a time longer than the time of detecting the touch operation for shifting the image from the personal information lock mode to the all-lock mode. Alternatively, when a touch operation for shifting the mode selection image 66 from the personal information lock mode to the standard mode, a warning image may be displayed, and the shift to the standard mode may be received only when the approval button included in the warning image is selected.

Thus, a first operation for switching from any of the second modes to the standard mode may be set so that it takes longer time for the operation unit 13 to operate the mode switching button, compared with a second operation for switching from the standard mode to any of the second modes. The first operation is an operation for changing to a direction in which information is disclosed in the remote operation image. The second operation is an operation for changing to a direction in which the operation is protected in the remote operation image. Thus, by making the first operation longer in operation time than the second operation, it is possible to prevent an erroneous operation such as unintentional disclosure of information.

The length of the operation time can be, for example, the length of the time of detecting the touch for receive the selection of the mode switching button, that is, the length of the time of a long press operation. In this case, a first tap operation for switching from any of the second modes to the standard mode is set so that it takes long time, compared with a second tap operation for switching from the standard mode to any of the second modes. With this configuration, when the user tries to perform the first tap operation, unless the user performs touching for a time longer than a time of the second tap operation, that is, unless the user performs a tap longer than a tap of the second tap operation, the user can not perform switching.

Similar ideas can be applied between buttons in another protection mode. For example, the operation for switching from the all-lock mode to any of the second modes or the standard mode may be set so that it takes long time for the operation unit 13 to operate the switching button, compared with the operation for switching from any of the second modes or the standard mode to the all-lock mode.

In the example in FIG. 12, the buttons for the respective protection modes are disposed in a cross, but the buttons may be disposed in a row, for example, in the vertical or horizontal direction. In such a case, for respective buttons, the protection modes may be disposed so that the closer a button is to the position of the button of the current protection mode, the more the information that can be protected.

The concept of protecting information according to the difficulty in operation on the mode selection image 66 can be applied to the operation on the mode switching button 61pi, such as the mode switching button 61pi in the operation image 60pi for displaying the mode selection image 66. For example, the configuration is set so that in a scene where a mode switching button indicating the all-lock mode is currently displayed in the operation image, it requires a large number of times to receive a touch operation or it takes long detection time to receive a touch operation, compared with in a scene where a mode switching button indicating another protection mode is displayed in the operation image. The configuration is set so that in a scene where a mode switching button indicating the standard mode is currently displayed in the operation image, it requires a small number of times to receive a touch operation or it takes short detection time to receive a touch operation, compared with in a scene where a mode switching button indicating another protection mode is displayed in the operation image. In a scene where the mode switching button indicating any of the second modes is currently displayed in the operation image, the number of times or the detection period for receiving a touch operation is set to a value between a scene where the mode switching button indicating the all-lock mode is displayed in the operation image and a scene where the mode switching button indicating the standard mode is displayed in the operation image.

The mark or the mode switching button indicating the protection mode shown in FIGS. 5 through 12 may be displayed at all times, but may be displayed only during remote operation, for example, when the display area is limited and there is another display item that should be given priority. When the mode switching button is displayed only during remote operation, immediately after the remote operation is initiated, for example, the all-lock mode should be the default protection mode at any time. This avoids the possibility that whole information is suddenly disclosed after starting the remote operation.

When the operation image includes a mode switching button, the corresponding mark may be displayed on the remote operation image as illustrated in FIGS. 5 through 11, but such a mark is not required to be displayed on the remote operation image. Thus, the remote operation image should include the switching button as a mere mark in the non-selectable state, or should not include the mode switching button. This avoids the possibility of a remote operator changing the protection mode.

### Effect of the Present Embodiment

As can be seen from the above description, according to the present embodiment, it is possible to protect information in a state where the operation from the external device 2 is allowed when the external device 2 displays and operates part or whole of the operation image of the image forming apparatus 1 via a network. For example, in the protection mode, described as the second mode, in which at least one of the personal information and the privacy information is hidden for protection, unlike the all-lock mode, part that is not related to the information to be hidden and part that is necessary for the operation are displayed on the remote operation image. Therefore, in this case, as in the standard mode, the remote operator as a proxy can perform an operation on the remote operation image. Thus, according to the present embodiment, the operation of the operation image by the remote operator can be allowed via the remote operation image, while protecting the personal information, privacy of the owner, and the like that the image forming apparatus 1 holds.

In addition, according to the present embodiment, such protection can be performed in accordance with the intention of the user of the image forming apparatus 1 by adopting a configuration in which the operation unit 13 of the image forming apparatus 1 can switch the protection mode. In other words, according to the present embodiment, in the image forming apparatus 1 with a remote panel function, the sharing of the operation image to be displayed on the display unit 12 by the remote operator can be set in stages. According to the present embodiment, with the configuration, it is possible to change the display of personal information and information related to the privacy of the owner managed by the image forming apparatus 1 depending on the situation.

For example, in the present embodiment, the information to be displayed on the remote panel can be switched step by step according to the protection mode set by the owner of the image forming apparatus 1, after classifying the registration information 11a of the image forming apparatus 1 into respective protection types such as privacy and personal information. The background image and the icon image that are customized by the owner of the image forming apparatus 1 corresponds to privacy in which the owner's taste can be read. When the owner thereof sets the privacy information to be private, the privacy information is replaced with the images of the default background and the default icon and the image is shared, so that the remote operator can perform the function of the remote panel while protecting the user's privacy. For example, information such as a contact registered in the image forming apparatus 1 corresponds to personal information. When the owner of the image forming apparatus 1 sets the personal information to be private, the personal information is replaced with a predetermined character string and the image is shared, so that the remote operator can perform the function of the remote panel while protecting the personal information.

A supplemental description of the use scene of the system 100 is made. In the system 100, for example, the external device 2 used by a remote operator located far away from the image forming apparatus 1 can receive the provision of the remote panel. Examples of the remote operators can include an information technology (IT) administrator, a service personnel, and a reseller engineer. These remote operators can perform troubleshooting and training for end users without having to visit the site where the image forming apparatus 1 is installed. For example, an IT administrator in a company where the image forming apparatus 1 is installed can directly access and use the image forming apparatus 1 from within the same intranet, using the external device 2.

### Modifications of Image Forming System

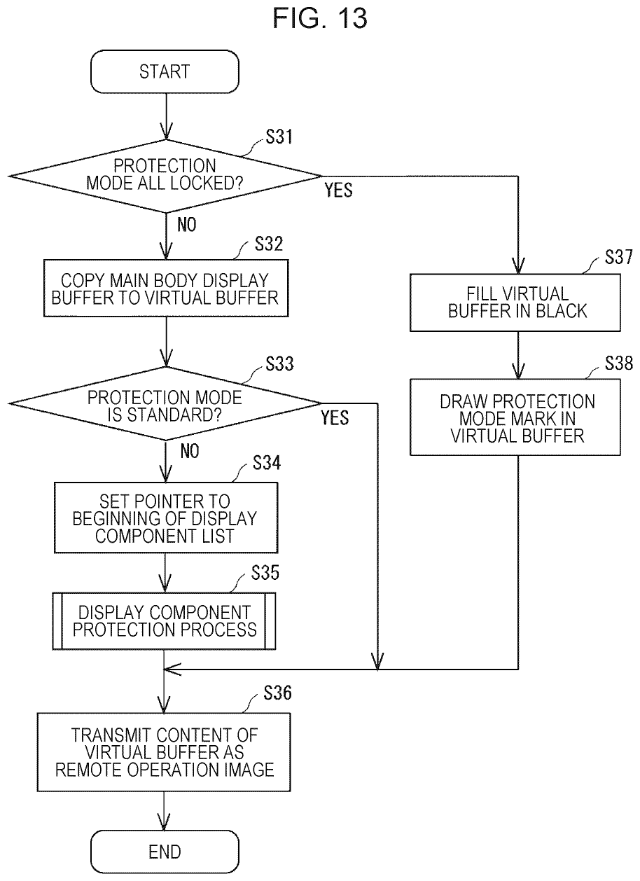

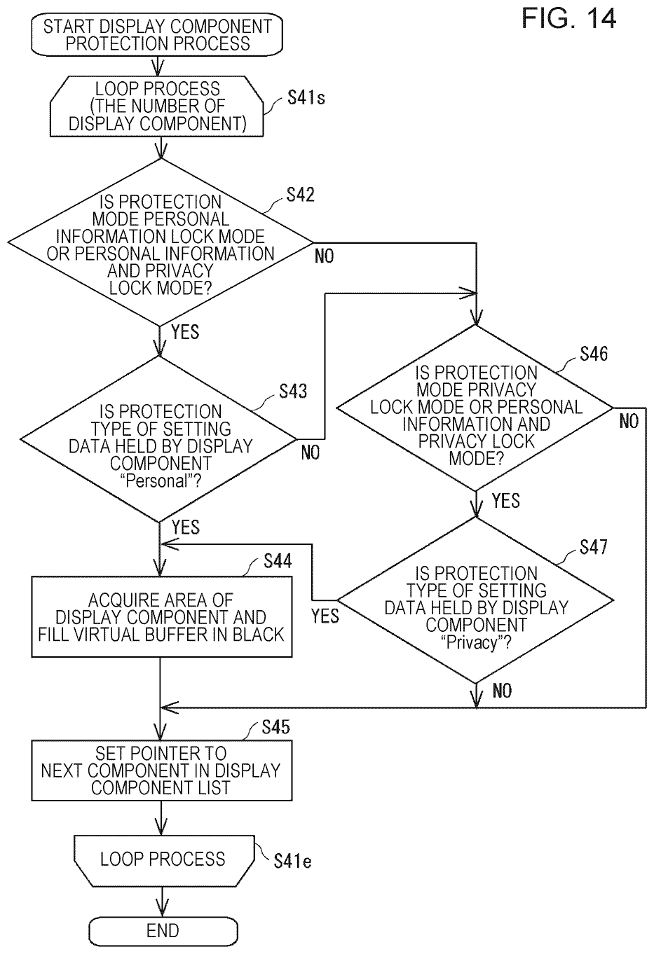

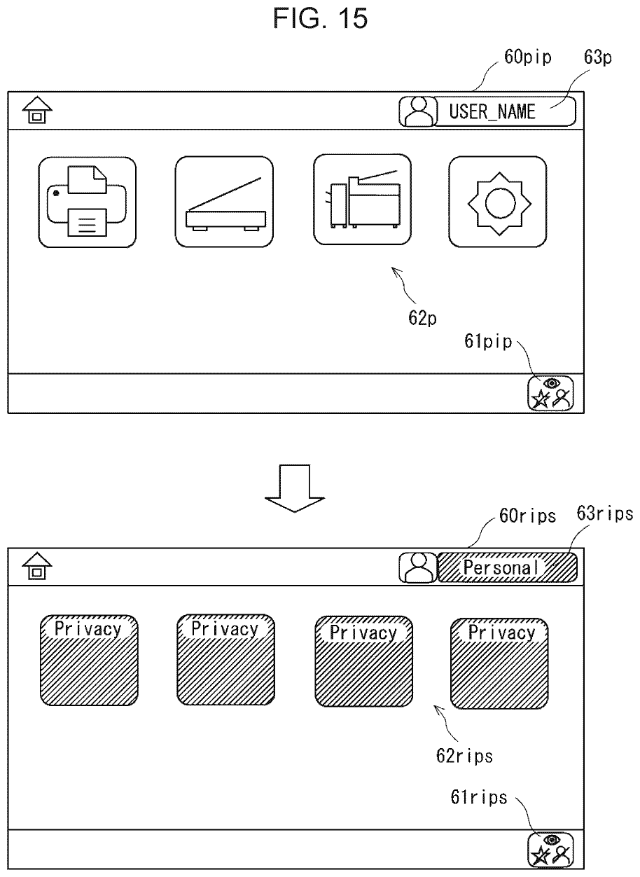

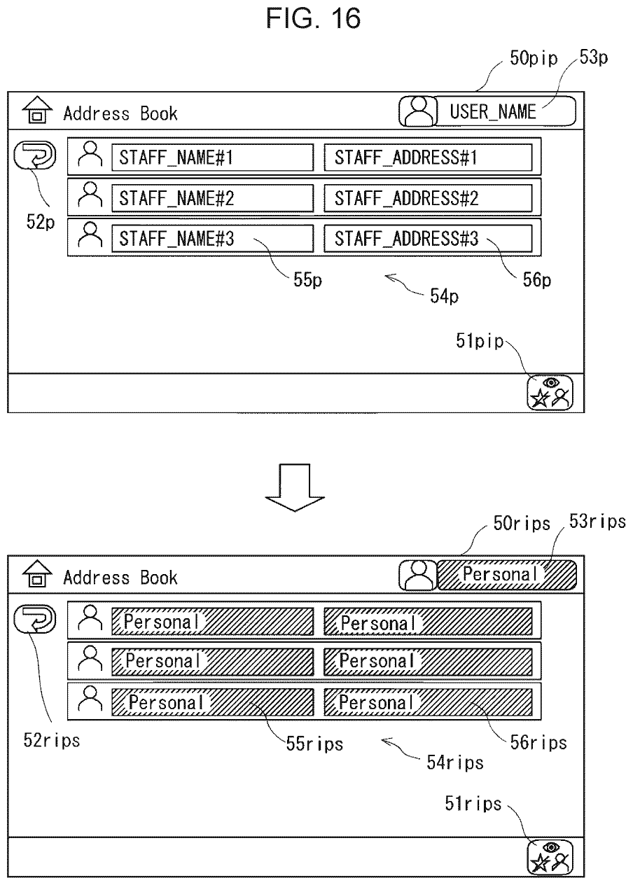

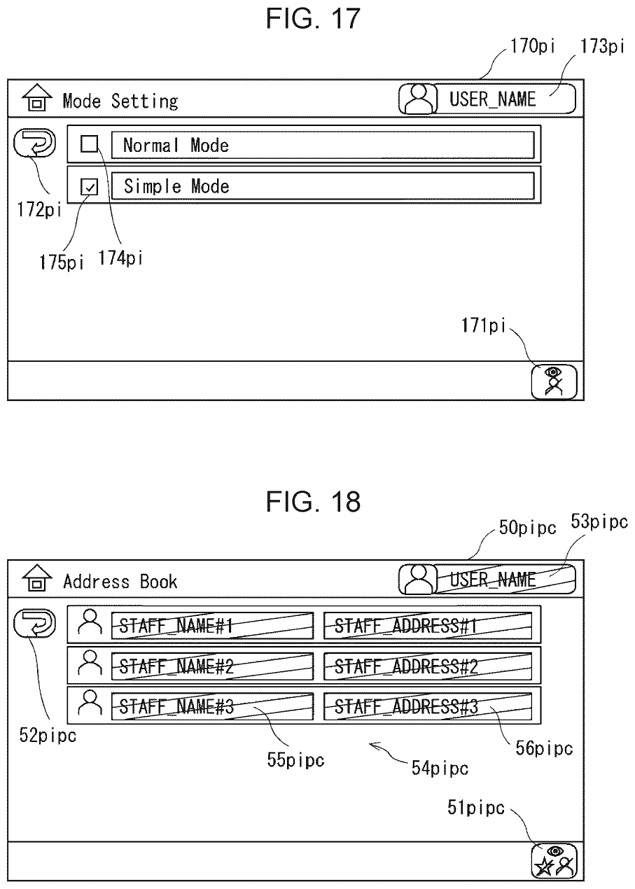

Modifications of the system 100 are described with reference to FIGS. 13 through 17. FIG. 13 is a flow diagram for describing a processing example of an image forming apparatus in a modification of the system 100. FIG. 14 is a flow diagram for describing an example of the display component protection process in the processing example shown in FIG. 13. FIG. 15 is a schematic diagram showing an example of an operation image in the personal information and privacy lock mode displayed in the processing example shown in FIG. 13 and an example of a remote operation image displayed corresponding to the operation image. FIG. 16 is a schematic diagram showing another example of an operation image in the personal information and privacy lock mode displayed in the processing example in FIG. 13 and an example of a remote operation image displayed corresponding to the operation image. FIG. 17 is a schematic diagram showing an example of an operation image displayed when setting the simple mode in the image forming apparatus 1 to execute the processing example shown in FIG. 13.

The image forming apparatus 1 in the modification is configured to simplify a drawing process, compared with the processing example in FIGS. 2 and 3. Hereinafter, the mode in which the simplified drawing process is performed is referred to as a simplified drawing mode, and the processing example in FIGS. 2 and 3 is referred to as a normal drawing mode.

Hereinafter, the process flow in the modification is described. First, the transmission processing unit 10a determines whether the current protection mode is the all-lock mode (step S31). When YES in step S31, that is, when the current protection mode is the all-lock mode, the transmission processing unit 10a fills the virtual buffer in black color (step S37) and draws a protection mode mark in the virtual buffer (step S38), as in steps S17 and S18 in FIG. 3. The transmission processing unit 10a then transmits the content of the virtual buffer to the external device 2 as a remote operation image (step S36) and terminates the process. In this case, for example, as illustrated in FIG. 6, the remote operation image 60ra filled in black except for the mark 61ra that is the same as the mark 61pa indicating that the operation image 60pa is the protection mode is displayed on the external device 2.

When NO in step S31, the transmission processing unit 10a copies the main body display buffer to the virtual buffer (step S32). Next to step S32, the transmission processing unit 10a determines whether the current protection mode is the standard mode (step S33).

When YES in step S33, that is, when the current protection mode is the standard mode, the transmission processing unit 10a transmits the content of the virtual buffer to the external device 2 as a remote operation image (step S36) and terminates the process. In this case, for example, as illustrated in FIG. 5, the operation image 50p is displayed as it is as the remote operation image 50r on the external device 2.

On the other hand, when NO in step S33, that is, when the current protection mode is any of the second modes, the transmission processing unit 10a sets the pointer to the beginning of the display component list of the remote operation image (step S34), as in step S13 in FIG. 2. Following step S34, the transmission processing unit 10a executes the display component protection process on the display component indicated by the pointer (step S35).

The display component protection process in the modification can be a loop process, as shown in FIG. 14, in which the process shown in steps S42 to S45 is executed until the process is finished for all display components in the display component list (steps S41s, S41e). In other words, the loop process is repeated by the number of display components.

In the loop process, the transmission processing unit 10a first determines whether the current protection mode is personal information lock mode or the personal information and privacy lock mode, as in step S22 in FIG. 3 (step S42). When NO in step S42, the transmission processing unit 10a determines whether the current protection mode is the privacy lock mode or the personal information and privacy lock mode, as in step S26 in FIG. 3 (step S46).

When YES in step S42, that is, when the current protection mode is a mode in which the personal information is protected, the transmission processing unit 10a executes a process similar to the process in step S23 in FIG. 3 (step S43). In step S43, it is determined whether the protection type of the setting data held by the target display component is “Personal”. When NO in step S43, the transmission processing unit 10a executes the process in step S46.

When YES in step S43, that is, when the target display component is a display component for which the personal information is protected, the transmission processing unit 10a acquires the area of the target display component and fills the virtual buffer in black (step S44). In step S44, a character string or a symbol indicating the protection type may be drawn after filling the virtual buffer in black. For example, “Personal” can be used here as a character string. Next, the transmission processing unit 10a sets the pointer to the next display component (step S45) and executes the process in step S42.

When YES in step S46, that is, when the current protection mode is a mode in which the privacy information is protected, the transmission processing unit 10a performs a process similar to the process in step S27 in FIG. 3 (step S47). In step S47, it is determined whether the protection type of the setting data held by the target display component is “Privacy”.

When YES in step S47, that is, when the target display component is a display component for which the privacy information is protected, the transmission processing unit 10a executes the process in step S44. In step S44, a character string or a symbol indicating the protection type may be drawn after filling the virtual buffer in black. For example, “Privacy” can be used here as a character string. When NO in step S47, the transmission processing unit 10a sets the pointer to the next display component (step S45) and executes the process in step S42. When NO in step S46, the process proceeds to step S45.

After the display component protection process described above, the transmission processing unit 10a transmits the content of the virtual buffer to the external device 2 as a remote operation image (step S36), and terminates the process. With the display component protection process, the remote operation image transmitted to the external device 2 is an image for which information is protected for the operation image, as exemplified in (5) to (6) below, for example.

### (5) Example of Remote Operation Image in Personal Information and Privacy Lock Mode

For example, in a scene where an operation image 60pip shown in FIG. 15 is displayed on the display unit 12, in step S36 after the process of step S44, a remote operation image 60rips with the personal information and the privacy information made private is transmitted to the external device 2. The reception processing unit 20a of the external device 2 then receives the remote operation image 60rips and display the remote operation image 60rip on the display unit 22.

The remote operation image 60rips is an example of a remote operation image, corresponding to the operation image 60pip, that is transmitted to the external device 2 and displayed on the display unit 22. The remote operation image 60rips is an image in which the icon group 62p in the operation image 60pip is replaced with an icon group 62rips filled in black and having the character string “Privacy” drawn. Furthermore, the remote operation image 60rips is an image obtained by filling the information 63p, in the operation image 60pip, indicating the name of the user of the image forming apparatus 1 in black and drawing the character string “Personal”. The remote operation image 60rips includes a mark 61rips that is the same as a mark 61pip.

### (6) Example of Remote Operation Image in Personal Information Lock Mode

For example, in a scene where the operation image 50pip shown in FIG. 16 is displayed on the display unit 12, in step S36 after the process of step S44, a remote operation image 50rips with the personal information made private is transmitted to the external device 2. The reception processing unit 20a of the external device 2 then receives the remote operation image 50rips and display the remote operation image 50rip on the display unit 22.

The operation image 50pip is the operation image 50pip in FIG. 11. The remote operation image 50rips is an example of a remote operation image, corresponding to the operation image 50pip, that is transmitted to the external device 2 and displayed on the display unit 22. The remote operation image 50rips is an image obtained by filling the information 53p and the information 55p and 56p included in the contact information 54p in the operation image 50pip in black and drawing the character string “Personal”. It can be seen that information 53rips, and information 55rips and 56rips included in contact information 54rips in the remote operation image 50rips are filled in black for the corresponding information in the operation image 50pip and have the character string “Personal” drawn is. The remote operation image 50rips includes a mark 51rips and a return button 52rips that are the same as the mark 51pip and the return button 52p, respectively.

As described above, the processing example in FIGS. 13 and 14 as a simplified drawing mode is described with examples of the operation image and the remote operation image. However, the processing example in FIGS. 13 and 14 is only an example in the modification. For example, the order of determining the protection mode can be changed, and processing can be applied accordingly.

In the normal drawing mode described in FIGS. 2 and 3, the process of determining the protection mode and replacing information for every display component is necessary. Therefore, in the normal drawing mode, the content of the operation image to be displayed on the display unit 12 cannot be transferred all at once, and components are redrawn for the remote operation image for each component to be drawn, resulting in a high processing load for the drawing process.

On the other hand, in the simplified drawing mode described in the modification, after the operation image to be displayed on the display unit 12 is copied to a virtual buffer, the display area of each display component is acquired and the area is filled in later. Therefore, in the simplified drawing mode, there is no need to consider the drawing order and only minimal overwriting processing is required, thus reducing the processing load, compared with the normal drawing mode.

However, in the simplified drawing mode, detailed drawing components cannot be replaced, and when there is an area to be protected that occupies the majority of the image, such as a background image, the area is filled in more than necessary. Therefore, the normal drawing mode looks better than the simplified drawing mode in a scene where the detailed display components or the background image are present or in the specifications of the image forming apparatus 1.

Thus, since both the simplified drawing mode and the normal drawing mode have their unique advantages, proper use of these drawing modes should be carried out. Therefore, the image forming apparatus 1 may include a function to switch the drawing mode between the simplified drawing mode and the normal drawing mode. Such switching of the drawing mode may be performed by the switching unit 10c, for example, based on the drawing mode set by user operation from the operation unit 13.

The drawing mode setting can be received by displaying an operation image on the display unit 12, such as an operation image 170pi shown in FIG. 17. The operation image 170pi can include, for example, a check box 174pi for selecting “Normal Mode” indicating the normal drawing mode and a check box 175pi for selecting “Simple Mode” indicating the simplified drawing mode. In addition, the operation image 170pi can include a mark 171pi indicating the current protection mode, information 173pi indicating the user, and a return button 172pi.

The user can select the drawing mode by selecting any one of the check boxes 174pi and 175pi in the operation image 170pi from the operation unit 13. The drawing mode can be registered, for example, as part of the security settings in the table 11b so as to be referenced at least before the drawing process. For example, based on the user's selection operation, whether the default drawing mode is either the normal drawing mode or the simplified drawing mode may be registered in the table 11b. Then, before starting transmitting the remote operation image, the switching unit 10c, for example, of the image forming apparatus 1 may switch the drawing mode between the normal drawing mode and the simplified drawing mode.

Of course, the image forming apparatus 1 in the modification may not have a drawing mode switching function, and drawing in the drawing process may be performed in the simplified drawing mode.

Since the drawing mode setting affects the remote operation image, the setting may be performed by operating the remote operation image displayed on the display unit 22 of the external device 2 from the operation unit 23. The remote operation image to be displayed when such a drawing mode setting operation is received from the operation unit 23 is an image whose information is protected according to the protection mode.

### Modifications of Operation Image

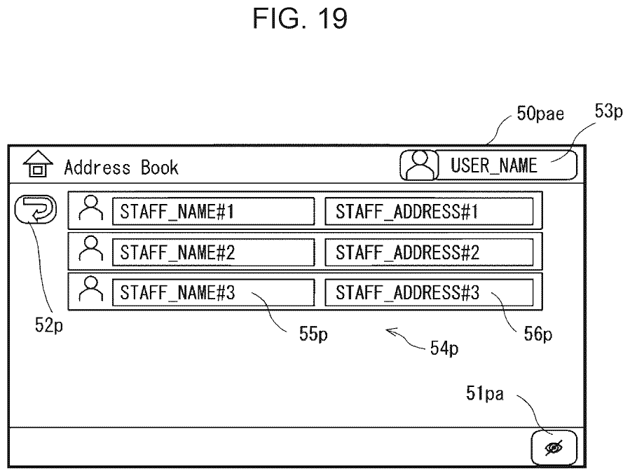

Modifications of the operation image displayed on the display unit 12 are described with reference to FIGS. 18 and 19. FIG. 18 is a schematic diagram showing another example of an operation image in the personal information and privacy lock mode displayed in the system 100. FIG. 19 is a schematic diagram showing another example of an operation image in the all-lock mode displayed in the system 100.

The operation image displayed on the display unit 12 may be displayed in such a way that the user of the image forming apparatus 1 can determine whether a component is protected in the remote operation image such as, for example, an operation image 50pipc shown in FIG. 18 or an operation image 50pae shown in FIG. 19.

The operation image 50pipc shown in FIG. 18 is an example of an operation image displayed on the display unit 12 in the personal information and privacy lock mode. The operation image 50pipc is an image in which the mark 51p indicating the standard mode in the operation image 50p in FIG. 5 is replaced with a mark 51pipc indicating the personal information and privacy lock mode. The operation image 50pipc includes a return button 52pipc, information 53pipc, and contact information 54pipc including information 55pipc and 56pipc as in the return button 52p, the information 53p, and the contact information 54p including the information 55p and 56p in the operation image 50p.

The information 53pipc, the information 55pipc, and the information 56pipc in the operation image 50pipc are images obtained by covering the information 53p, the information 55p, and the information 56p in the operation image 50p in FIG. 5 by a light color image with α blended. A light color here is only required to be any color that is lightened as a result of xx blending, such as green, blue, yellow, red, and the like.

The operation image 50pae shown in FIG. 19 is an example of an operation image displayed on the display unit 12 in the all-lock mode. The operation image 50pae is an image in which the mark 51p indicating the standard mode in the operation image 50p in FIG. 5 is replaced with a mark 51pa indicating the all-lock mode. Furthermore, the operation image 50pae has its outer frame changed to a predetermined color to indicate that the corresponding remote operation image protects the entire image. The above predetermined color can be any color, such as green, yellow, red, and the like.

Thus, the display unit 12 may display the operation image with the registration information 11a having a different display form according to the protection mode. This allows the user of the image forming apparatus 1 to be notified of the information to be protected. In addition, the display form for notifying a user of information to be protected is not limited to the examples in FIGS. 18 and 19, but can be a form of, for example, a notification by a speech balloon or message. In any examples, for example, such a drawing for notification should be performed according to the protection mode before displaying the operation image on the display unit 12.

### Other Modifications of Image Forming Apparatus 1

As mentioned above, the user who registered the registration information 11a may be a user as the administrator of the image forming apparatus 1, but is only required to be a user of the image forming apparatus 1. When a plurality of users has registered their registration information 11a, the registration information 11a can be collectively processed according to the protection mode to display the remote operation image. Alternatively, when a plurality of users has registered the registration information 11a, the registration information 11a of a user who is in a state of using the image forming apparatus 1, such as who has currently logged into the image forming apparatus 1 can be processed according to the protection mode to display the remote operation image. In such a case, the registration information 11a registered by another user who has not logged in may not be displayed in the remote operation image without depending on the protection mode.

The display components to be protected and the granularity of protection may vary depending on the functions, display performance, and operational performance of the image forming apparatus 1. The image forming apparatus 1 may also have dedicated buttons for setting a protection mode, a drawing mode, a display component to be protected, and the like. Another network configuration example of image forming systems

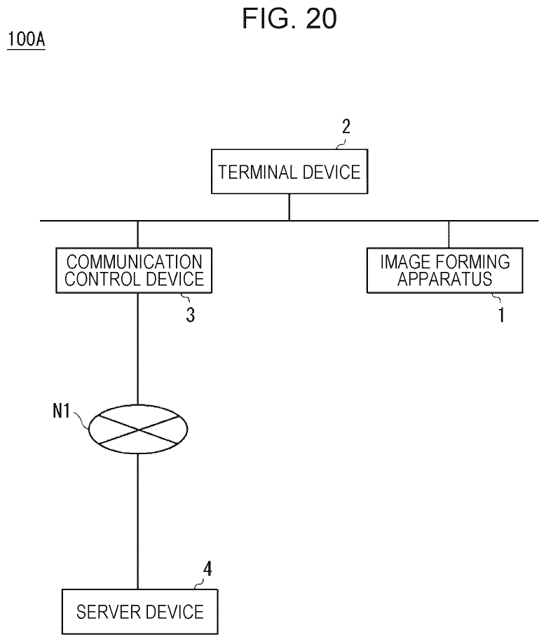

Another configuration example of the image forming system according to the present embodiment is described with reference to FIG. 20. FIG. 20 is a schematic block diagram showing another configuration example of an image forming system including an image forming apparatus and a terminal device according to the present embodiment.

The image forming system according to the present embodiment can be an image forming system 100A with a network configuration example as shown in FIG. 20. In the image forming system 100A, the external device 2 and the image forming apparatus 1 are connected by a local area network (LAN), and a communication control device 3 such as a router is connected to the LAN. The LAN can be, for example, a LAN of the company where the image forming apparatus 1 is installed. The communication control device 3 is a device that controls communication between the devices in the LAN and a network N1. A server device 4 is connected to the network N1.

The server device 4, although the details thereof are omitted, can be a server computer with the function to provide a remote panel to the external device 2. The server device 4 may, for example, include a reception server device that communicates with the external device 2 and a base server device that is connected to the reception server device and communicates with the image forming apparatus 1, with the functions thereof distributed among them. The reception server device can be a server device that provides the external device 2 with a process of receiving operations from the external device 2. The base server device can be a server device that provides the image forming apparatus 1 with a process of operating the operation image of the image forming apparatus 1 based on the operations received by the reception server device. The image forming system 100A may be a system with three or more server devices having further distributed functions. In other words, the image forming apparatus 1 is only required to have a configuration to communicate with the external device 2 via at least one information processing device, such as at least one server device. In this case, the external device 2 is configured to communicate with the image forming apparatus 1 via at least one information processing device, such as at least one server device. Of course, the network configurations that can be applied in the present embodiment are not limited to those illustrated in FIGS. 1 and 20.

The use scene of the image forming system 100A is described. In the image forming system 100A, as in the system 100, for example, the external device 2 used by a remote operator who is located far away from the image forming apparatus 1 can receive the provision of the remote panel. For example, in the image forming system 100A, an IT administrator in a company where the image forming apparatus 1 is installed can access and use the image forming apparatus 1 via the server device 4 installed outside of the intranet, using the external device 2 in the same intranet. In the image forming system 100A, a service person or a reseller engineer outside the company where the image forming apparatus 1 is installed can access and use the image forming apparatus 1 via the server device 4, using the external device 2.

### Other Modifications

The present disclosure is not limited to the above embodiments, and can be modified as appropriate without departing from the scope of the disclosure. For example, the image forming apparatus applied to the image forming system according to the present embodiment can be widely applied to a copier, a facsimile, and a multifunctional machine with these functions, as can be understood, for example, from the operation image in FIG. 6 or the like.

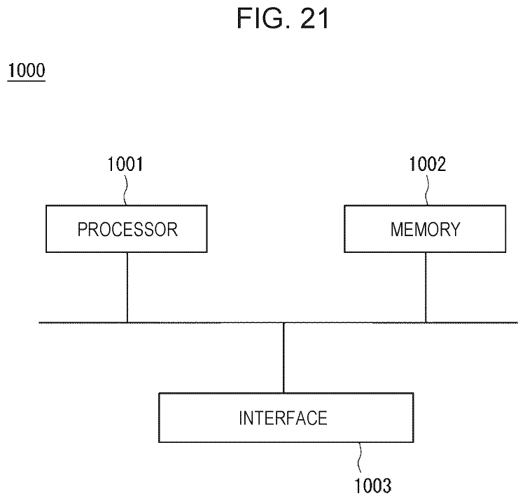

In addition, each of the devices in the image forming system according to the embodiments described above can include the following hardware configurations, for example. FIG. 21 shows an example of the hardware configuration of the device.

A device 1000 shown in FIG. 21 can include a processor 1001, a memory 1002, and an interface 1003. The interface 1003 can include, for example, a communication interface, an interface with a sensor, an input/output device, and the like, which are necessary depending on the device.

The processor 1001 may be, for example, a CPU, a graphics processing unit (GPU), a micro processor unit (MPU) also referred to as a microprocessor, or the like. The processor 1001 may include a plurality of processors. The memory 1002 is configured by, for example, a combination of a volatile memory and a nonvolatile memory. The functions of each device are implemented by the processor 1001 reading a program stored in the memory 1002 and executing the program while exchanging necessary information via the interface 1003.

The program described above includes an instruction group (or software code) that, when read into a computer, cause the computer to perform one or more of the functions described in the present embodiments. The program may be stored in a non-transitory computer-readable medium or a tangible storage medium. By way of example and not limitation, the computer-readable medium or the tangible storage medium may include a random-access memory (RAM), a read-only memory (ROM), a flash memory, a solid-state drive (SSD), or another memory technology. By way of example and not limitation, the computer-readable medium or the tangible storage medium may include a CD-ROM, a digital versatile disc (DVD), a Blu-ray (registered trade mark) disc or another optical disc storage, a magnetic cassette, a magnetic tape, and a magnetic disk storage or another magnetic storage device. The program may be transmitted on the transitory computer-readable medium or the communication medium. By way of example and not limitation, the transitory computer-readable medium or the communication medium includes electrical, optical, acoustic, or other forms of propagated signals.

As described above, the present disclosure is described in accordance with the above embodiments, but the present disclosure is not limited only to the configurations of the above embodiments, and, of course, includes various variations, modifications, and combinations that a person skilled in the art could make within the scope of the disclosure of the claims of the present application.

What is claimed is:

1. An image forming apparatus comprising:
a communication unit;
an operation unit;
a display unit displaying an operation image operable from the operation unit;
a transmission processing unit transmitting, via the communication unit, display information for displaying a remote operation image based on the operation image to an external device; and
a switching unit for switching a disclosure mode for information disclosure in the remote operation image, wherein
the disclosure mode includes
a first mode in which prescribed information included in part of the operation image is included in the display information and registration information that is information registered by a user is included in the display information, the registration information being included in part of the operation image, and
a second mode in which the prescribed information is included in the display information and the registration information is not included in the display information.

2. The image forming apparatus according to claim 1, wherein
the disclosure mode further includes a third mode in which the prescribed information is not included in the display information and the registration information is not included in the display information.

3. The image forming apparatus according to claim 1, wherein
the operation image includes a switching button for switching the disclosure mode, and wherein
an operation for switching from the second mode to the first mode is set so that it takes long time for the operation unit to operate the switching button, compared with an operation for switching from the first mode to the second mode.

4. The image forming apparatus according to claim 1, wherein
the registration information includes at least one of a background image that serves as a background in the operation image and an icon image indicating a selectable icon.

5. The image forming apparatus according to claim 1, wherein
the registration information includes information indicating a contact registered by the user.

6. The image forming apparatus according to claim 1, wherein
the registration information includes information indicating a password registered by the user.

7. The image forming apparatus according to claim 1, wherein
the operation image includes a switching button for switching the disclosure mode, and wherein
the display information includes the switching button in a non-selectable state or does not include the switching button.

8. The image forming apparatus according to claim 1, wherein
the display unit displays the operation image with the registration information having a different display form according to the disclosure mode.

9. The image forming apparatus as claimed in claim 1, wherein
the switching unit sets the disclosure mode to the second mode when the transmission processing unit starts transmitting the display information.

10. The image forming apparatus according to claim 2, wherein
the switching unit sets the disclosure mode to the third mode when the transmission processing unit starts transmitting the display information.

11. An information transmission method comprising:
an image forming apparatus transmitting, via a communication unit, display information for displaying a remote operation image based on the operation image to an external device, the image forming apparatus including the communication unit, an operation unit, and a display unit displaying an operation image operable from the operation unit; and
the image forming apparatus switching a disclosure mode regarding information disclosure in the remote operation image, wherein
the disclosure mode includes
a first mode in which prescribed information included in part of the operation image is included in the display information and registration information that is information registered by a user is included in the display information, the registration information being included in part of the operation image, and
a second mode in which the prescribed information is included in the display information and the registration information is not included in the display information.
